(19) United States
(12) Patent Application Publication
(10) Pub. No.: US 2026/0072282 A1
(43) Pub. Date: Mar. 12, 2026

(54) IMAGE DISPLAY DEVICE

(71) Applicant: COMMISSARIAT A L'ENERGIE ATOMIQUE ET AUX ENERGIES ALTERNATIVES, Paris (FR)

(72) Inventors: Christophe MARTINEZ, Grenoble Cedex 09 (FR); Salaheddine TOUBI, Grenoble Cedex 09 (FR); Yann LEE, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/323,340

(22) Filed: Sep. 9, 2025

(30) Foreign Application Priority Data
Sep. 10, 2024 (FR) FR2409629

(51) Int. Cl. G02B 27/01; G02F 1/1343

(52) U.S. Cl. CPC G02B 27/0176; G02B 27/0172; G02F 1/134318; G02B 2027/0112; G02B 2027/015; G02B 2027/0174

(57) ABSTRACT

The invention relates to a device for displaying an image comprising a matrix of extraction structures and sets of waveguides and addressing electrodes extending respectively along axes xi and ya, ya forming an angle β with an axis yi orthogonal to xi. Each extraction structure comprises an intermediate waveguide of a liquid crystal arranged between an addressing electrode and a common electrode so as to switch its index from a first level to a second level. An input face of the intermediate waveguide forms an angle γ greater than 30 degrees with the substrate and an angle equal to β with the axis yi. In operation, a mode of the addressing waveguide is coupled to the intermediate waveguide only when the liquid crystal index is equal to the second level to extract a beam corresponding to the display of a pixel, after total reflection on the input face of the adjacent extraction structure.

### TECHNICAL FIELD

The field of the invention is that of devices for displaying an image, such as microdisplays which can for example be used for extended reality (augmented reality, virtual reality or mixed reality) applications.

### STATE OF PRIOR ART

Display devices such as microdisplays are used for many applications. They are used, for example, in video projectors, extended reality glasses, virtual reality headsets, or even to display information in eyepieces for still cameras, binoculars or movie cameras. Among numerous parameters that characterize the performance level of a microdisplay, power consumption, resolution and compactness are particularly important. The overall compactness of the systems that integrate them is generally of interest.

Document C. Martinez et al. “See-through holographic retinal projection display concept”, Optica, vol. 5, no 10, p. 120 October 2018, doi: 10.1364/OPTICA.5.001200 describes a particularly compact augmented reality system integrating a microdisplay making use of an autofocus effect. This type of microdisplay makes it possible to dispense with an optical system to project an image into a user's eye, and can therefore be integrated into less complex, less bulky and less heavy augmented reality systems.

In general terms, a pixel of such a screen results from the combination of several light waves that are coherent with each other, derived from a distribution of emission points. The light is caused to face the emission points by an array of integrated waveguides, optically connected to a light source. Each emission point comprises an active extraction structure for extracting light on command from a corresponding waveguide. A holographic film disposed on the active extraction structures allows adjusting the phase and direction of light extracted by the active extraction structures. For example, the emission points may emit light waves having the same modulo 2π phase and propagating about parallel main axes. In this case, the observer's eye sees a sharp point corresponding to a virtual pixel located to infinity. A control circuit connected to the light source and an array of electrodes enables the light source and the extraction structures corresponding to the pixel to be simultaneously activated.

Like this microdisplay, the operation of which has just been briefly described, there are other microdisplays with guided light distribution, comprising emission points optically coupled to one or more light sources by an array of integrated waveguides. They are generally advantageous for their compactness, especially for use in so-called “near-eye” optical systems, such as augmented reality glasses. However, it is necessary to reduce their power consumption. For this, it is for example desirable to increase directivity of light extracted at each emission point, so as not to lose light flux between the microdisplay and a user's eye.

Guided light distribution microdisplays frequently integrate diffraction gratings to extract light at the emission points. However, these gratings generally diffract light in one or more unnecessary diffraction orders, yielding optical losses and possibly one or more parasitic images. Furthermore, light can be extracted efficiently, without energy loss, only for a large length of the diffraction grating, which impairs the compactness or definition of the microdisplay.

### DISCLOSURE OF THE INVENTION

One purpose of the invention is to at least partly remedy the drawbacks of prior art, and more particularly to provide a compact image display device, consuming less electric power than display devices of the state of the art.

For this, the object of the invention is a device for displaying an image consisting of a set of pixels, comprising a substrate provided with an orthogonal reference frame and comprising an upper face; an illumination module; a common electrode; a set of addressing waveguides optically coupled to the illumination module, extending in parallel to an oriented axis xa, parallel to xi; a set of addressing electrodes extending in parallel to an oriented axis ya, forming an angle β with the axis yi; a matrix of light extraction structures. The display device is such that the common electrode, the matrix of extraction structures, the set of addressing waveguides, and the set of addressing electrodes successively extend from the upper face, in distinct planes parallel to the upper face.

Each extraction structure of the matrix is arranged at an intersection of an addressing waveguide and an addressing electrode, and comprises an intermediate waveguide in a liquid crystal extending in parallel to the upper face from an input face of the intermediate waveguide to an output face of the intermediate waveguide, the intermediate waveguide being arranged between the addressing electrode and the common electrode so as to switch a refractive index of the liquid crystal along a direction of polarization, from a first level to a second level strictly greater than the first level, when a variation in an electric potential difference is applied between the addressing electrode and the common electrode, and the input face forming an angle γ with the upper face of the substrate greater than or equal to 30 degrees and an angle equal to the angle β with the axis yi; a high index region extending from the output face of the intermediate waveguide, to the input face of an adjacent extraction structure of the matrix of extraction structures, the high index region having a refractive index nₚ strictly greater than the first level.

The display device is configured such that for each extraction structure, the first level, the second level and the arrangement of the intermediate waveguide with respect to the addressing waveguide are such that an optical mode derived from the illumination module and guided in the addressing waveguide, is at least partly coupled, by evanescent coupling from the addressing waveguide to the intermediate waveguide, only when the refractive index of the liquid crystal is equal to the second level so as to generate an emitted beam propagating in the high index region from the output face to the input face of the adjacent extraction structure; and the angle β is greater than or equal to a strictly positive minimum inclination angle beyond which the emitted beam is reflected by total internal reflection on the input face of the adjacent extraction structure into a reflected beam, to be extracted from the display device into a pixel beam corresponding to the display of a pixel of the image.

Some preferred, yet non-limiting, aspects of this image display device are as follows.

Each addressing waveguide of the set may have a rectilinear portion; the rectilinear portions may form a periodic array with a period p along the axis yi; the addressing electrodes may intersect the addressing waveguides at the rectilinear portions; the matrix of light extraction structures may be periodic with a period L_{c} along the axis xa; and wherein L_{C} is strictly greater than p.

L_{C} may be such that for each extraction structure, the intensity of the emitted beam may be greater than or equal to 80% of the intensity of the optical mode.

The angle β can be equal to

$$arccos ( \sqrt{\frac{p}{{L}_{C}}} ) .$$

The difference between nₚ and the second level may be less than or equal to 0.05 in absolute value.

For each addressing electrode, the intermediate waveguides of the extraction structures located at the intersections between the addressing electrode and the addressing waveguides of the set may be portions of a common planar waveguide.

The display device may further comprise a transparent cover with an optical index nv strictly lower than nₚ. Each extraction structure of the matrix may further comprise a hologram facing the input face of the adjacent extraction structure configured to deflect the reflected beam so as to reduce a propagation angle in the cover of the reflected beam relative to a normal to a main plane of the cover. Each hologram may be housed in the cover or on a face of the cover opposite to the high index region.

The hologram can be a reflection hologram.

The angle γ may be less than or equal to 45 degrees.

The addressing waveguides may each comprise a distinct optical modulator, arranged between the illumination module and the matrix of light extraction structures.

The image may be divided into several contiguous display zones, each of which may correspond to a set of adjacent addressing waveguides, optically coupled to a distinct light source of the illumination module.

The display device may further comprise an addressing circuit electrically connected to the set of addressing electrodes, the set of addressing electrodes may be divided into contiguous addressing zones, each of which may consist of a group of adjacent addressing electrodes. The addressing circuit may be configured to sequentially polarize, one by one, the addressing electrodes of each addressing zone so as to switch the refractive index of the liquid crystal of the corresponding intermediate waveguides to the second level.

All addressing zones may comprise the same number of addressing electrodes.

The addressing circuit can be configured to simultaneously bias an addressing electrode of each addressing zone.

The addressing electrodes may be arranged such that each pair of addressing electrodes simultaneously biased and belonging to contiguous addressing zones, activate two extraction structures of the matrix located at two opposite ends of the matrix of extraction structures and facing two adjacent addressing waveguides.

The addressing circuit can bias the addressing electrodes one by one according to the same sequence in all the addressing zones.

The display device may further comprise an image conversion circuit configured to convert a standard image consisting of an orthogonal matrix of pixels, into the image to be displayed by the display device.

The image to be displayed and the standard image can have the same number of pixels to within 10%, and the same aspect ratio to within 10%.

The invention also relates to a display system comprising a first and a second device for displaying an image, each according to any one of the preceding characteristics. The first and second image display devices may be arranged above each other such that pixel beams of the first display device pass through the matrix of addressing structures of the second display device.

The optical modes derived respectively from the lighting modules of the first and second display devices may have different wavelengths.

The display system may be configured to display a color image and the matrices of extraction structures of the first and second display devices may be arranged relative to each other such that the sets of pixels of the images to be displayed by the first and second display devices are color sub-pixels of the color image.

The respective sets of addressing waveguides of the first and second display devices may be interlaced in a display plane of the display system, parallel to the upper face of the substrate, and each addressing electrode of the first display device may be an addressing electrode of the second display device.

The output faces of the intermediate waveguides of the first and second display devices May form an angle with the upper face of the substrate equal to γ, and an angle with the axis vi equal to β.

Each common planar waveguide of the first display device may be a common planar waveguide of the second display device.

The invention also relates to a method for manufacturing an image display device according to any one of the preceding characteristics, comprising providing a lower part of the display device comprising the set of addressing waveguides; providing a cover; forming a structured layer on the lower part or the cover, by a nanoimprint lithography method, such that the structured layer comprises protruding parts with identical heights, equal to a common height; forming an adhesive bead on the lower part or on the cover, such that the adhesive bead has a thickness greater than or equal to the common height, delimits a central region, and comprises a through lateral opening communicating with the central region; transferring the cover to the lower part so that the structured layer plays the role of a spacer setting a gap between the cover and the lower part, and delimits continuous volumes in the central region; bonding the cover to the lower part by the adhesive bead; introducing a liquid crystal into each continuous volume via the through lateral opening to obtain the intermediate waveguide of each extraction structure.

The nanoimprint lithography method may comprise a sub-step of forming a reference mold which may comprise one or more of the following tasks: providing a master substrate of crystalline silicon, anisotropic wet etching trenches in the master substrate from an upper face of the master substrate so as to coincide a face, so-called face of interest, of each trench with a predetermined crystalline plane of the silicon. The nanoimprint lithography method may comprise a sub-step of forming a stamp by molding on the reference mold, and/or a sub-step of forming the structured layer by molding a film with the stamp so that faces of the stamp corresponding to faces of interest form the input faces of the extraction structures of the matrix.

The stamp may be soft, the film may be an UV-curable adhesive, and forming the structured layer may implement UV lighting the UV-curable adhesive prior to removing the stamp.

The UV-curable adhesive may have a refractive index equal to nₚ, and the difference between nₚ and the second level may be less than or equal to 0.05 in absolute value.

The manufacturing method may further comprise a step of forming a matrix of holograms which may comprise one or more of the following sub-steps: providing a support plate and a holographic film on a contact face of the support plate, transferring a plate with planar and parallel faces onto the holographic film, transferring a prism on a face of the plate opposite to the holographic film, repeating a sequence which may comprise lighting a zone of the holographic film by a reference beam forming a predetermined incidence angle with an input face of the prism and an object beam, coherent with the reference beam, forming an angle, so-called display angle, with a normal to the contact face, the incidence angle being predetermined such that the reference beam forms an angle with the contact face equal to an angle of the reflected beam of each extraction structure with the upper face of the substrate. The sequence can further comprise relatively moving the prism by one pitch of the matrix of holograms. The manufacturing method may further comprise a step of transferring the holographic film to the display device so as to place each hologram facing an input face of an extraction structure.

The display angle can vary from one iteration to another in the sequence.

The master substrate may have an orientation and the predetermined crystalline plane may be a plane (111) or (110).

The master substrate may be a silicon-on-insulator wafer.

### BRIEF DESCRIPTION OF THE DRA WINGS

Other aspects, aims, advantages and characteristics of the invention will become apparent upon reading the following detailed description of preferred embodiments thereof, provided as a non-limiting example, and made with reference to the appended drawings wherein:

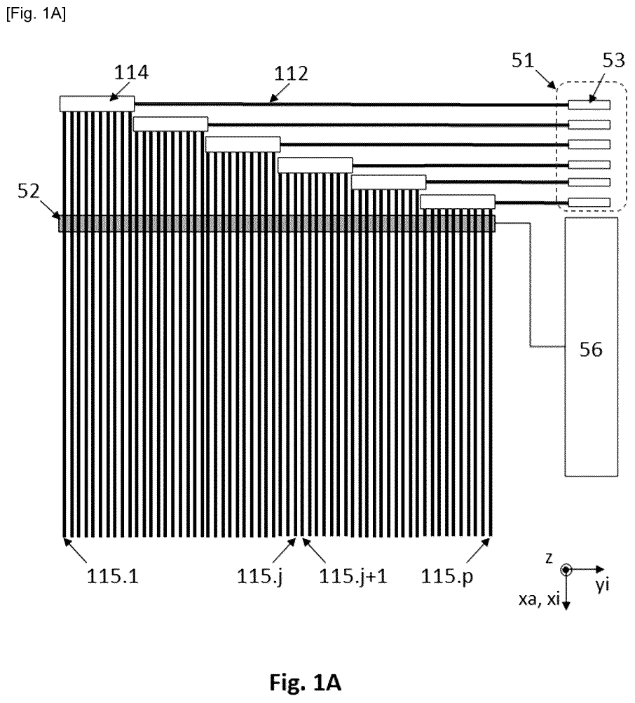

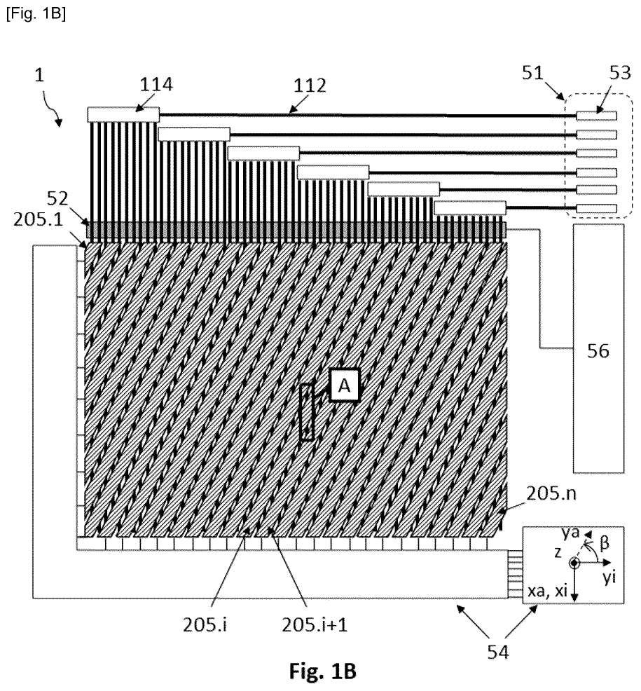

FIG. 1A is a schematic top view of an example display device according to the invention, on which only some elements have been represented;

FIG. 1B is a schematic top view of the example display device, to which elements have been added with respect to FIG. 1A;

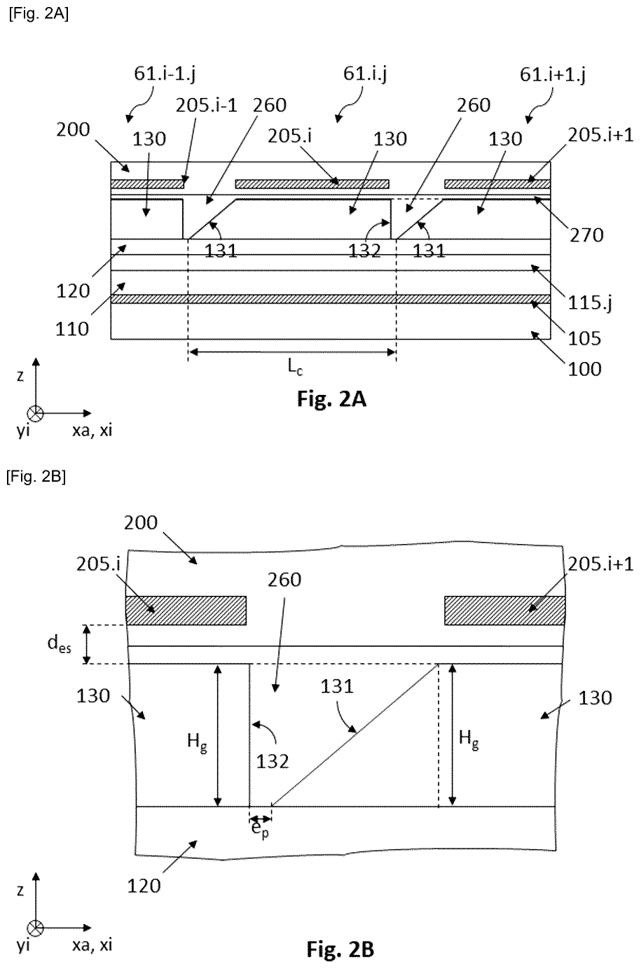

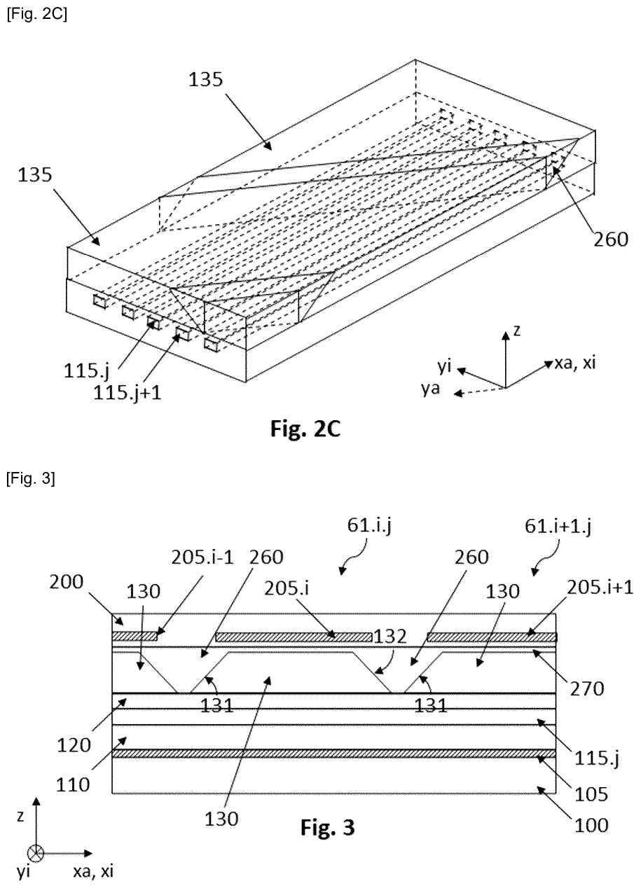

FIG. 2A is a schematic cross-section view of detail A of FIG. 1B, according to a first possibility;

FIG. 2B is a detail of FIG. 2A;

FIG. 2C is a schematic perspective view of some elements of detail A of FIG. 1B;

FIG. 3 is a schematic cross-section view of detail A of FIG. 1B, according to a second possibility;

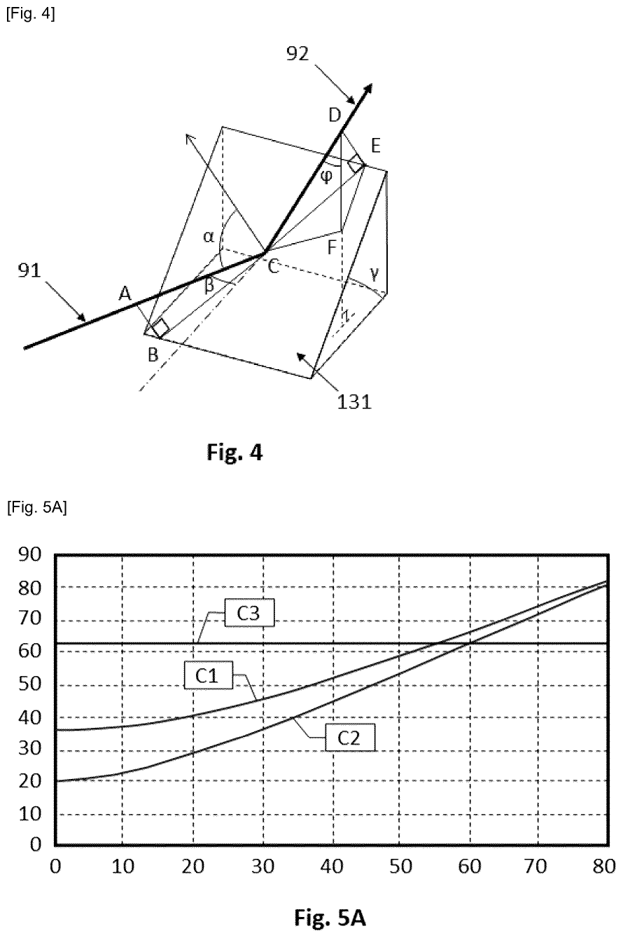

FIG. 4 is an optical diagram for introducing angles useful for understanding the invention;

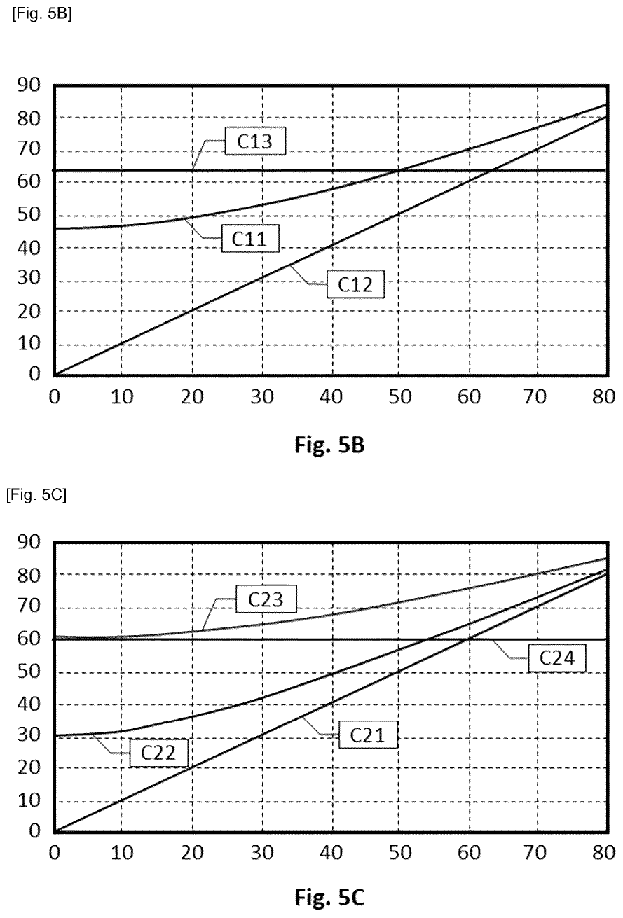

FIG. 5A is a first graph of angular correspondence between angles utilized by the example display device;

FIG. 5B is a second graph of angular correspondence between angles utilized by the example display device;

FIG. 5C is a third graph of angular correspondence between angles utilized by the example display device;

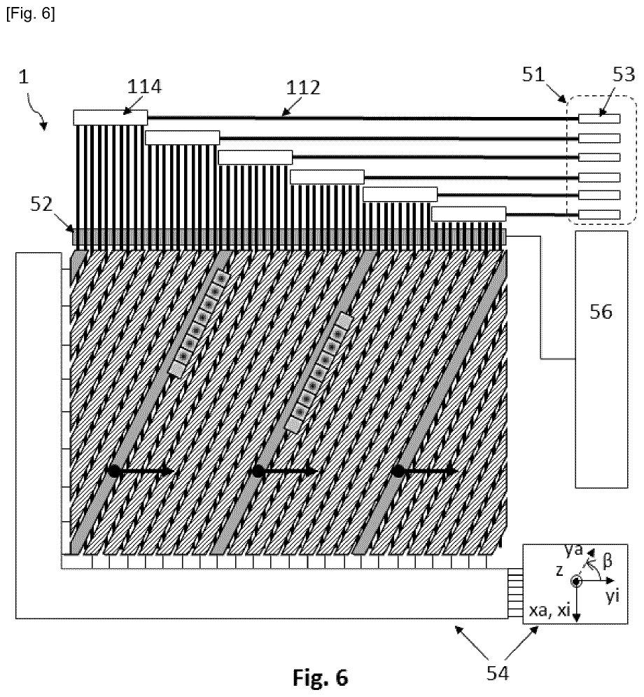

FIG. 6 is a schematic top view of the example display device in operation;

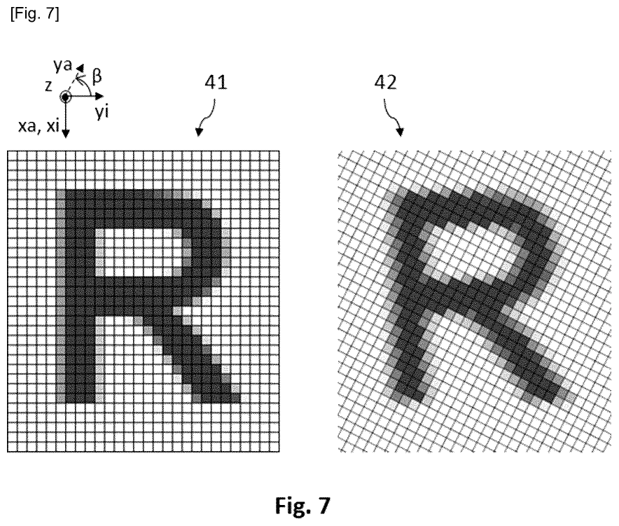

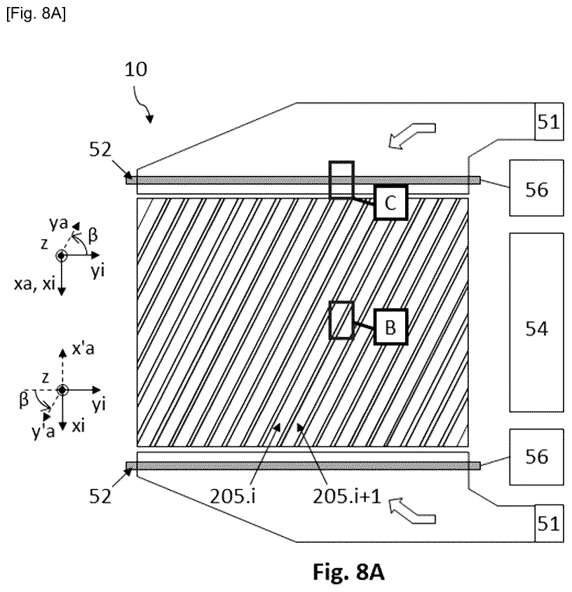

FIG. 7 are details of a standard image and an image displayed by the example display device from the standard image;

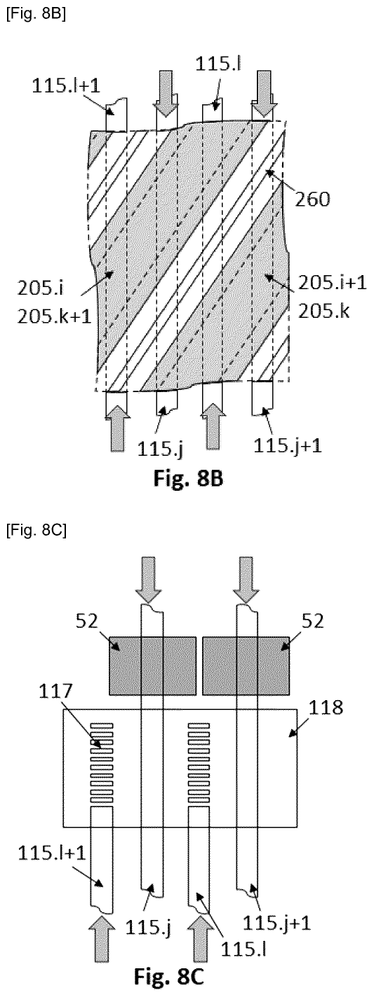

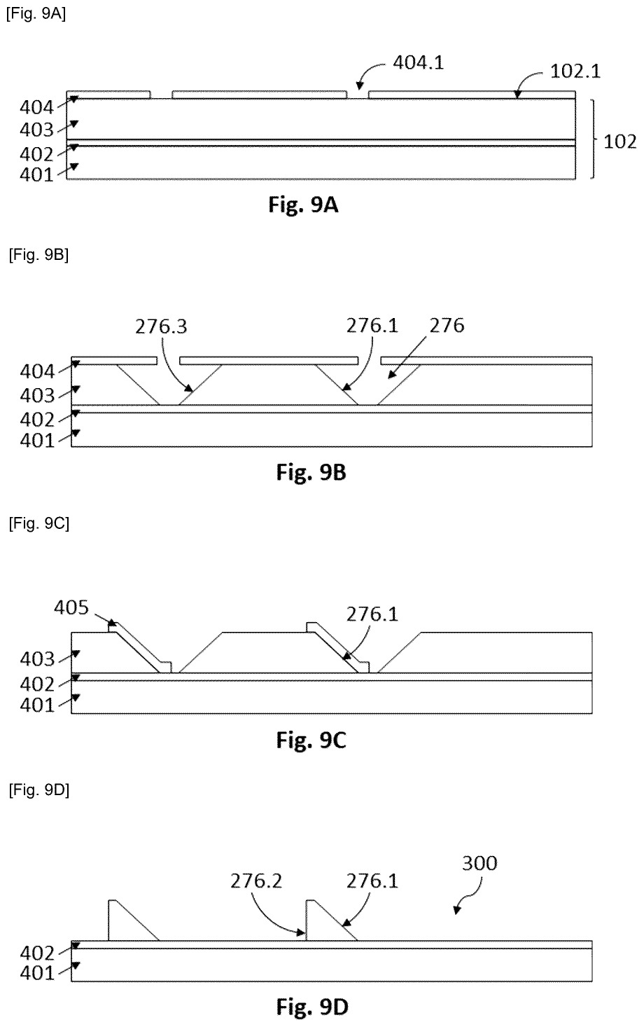

FIG. 8A is a schematic top view of an example display system comprising two display devices according to the invention;

FIG. 8B is a schematic top view of detail B of FIG. 8A;

FIG. 8C is a schematic top view of detail C of FIG. 8A;

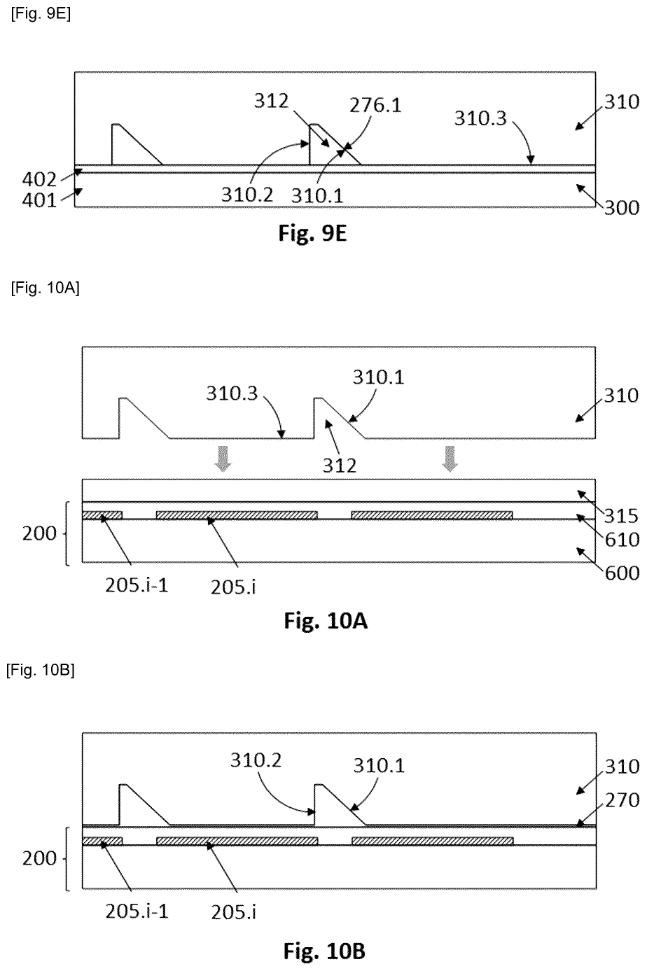

FIGS. 9A to 9E are schematic cross-section views of a first method for manufacturing a reference mold and a stamp specially designed for implementing a method for making the example display device;

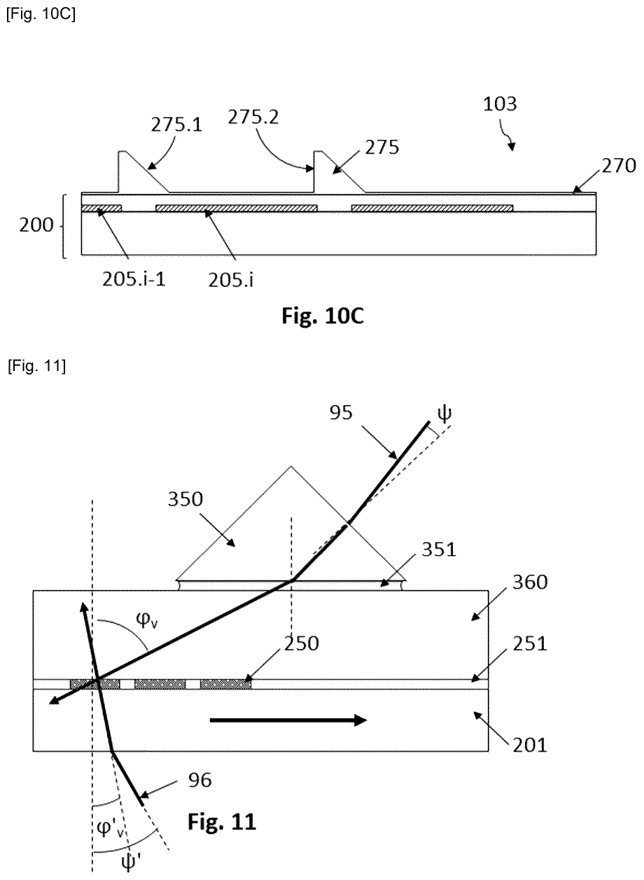

FIGS. 10A to 10C are schematic cross-section views of steps of a method for manufacturing an upper part of the example display device;

FIG. 11 is a schematic cross-section view of a method for manufacturing a matrix of holograms specially designed for implementing the method for manufacturing the example display device;

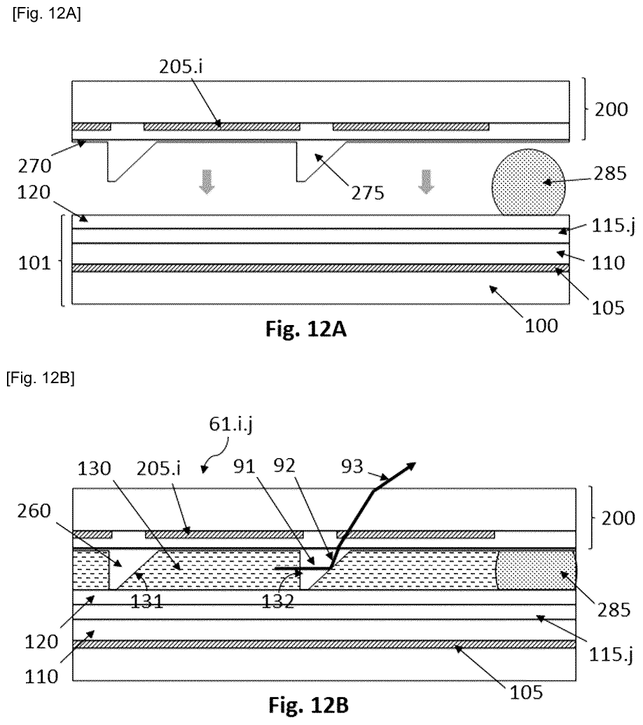

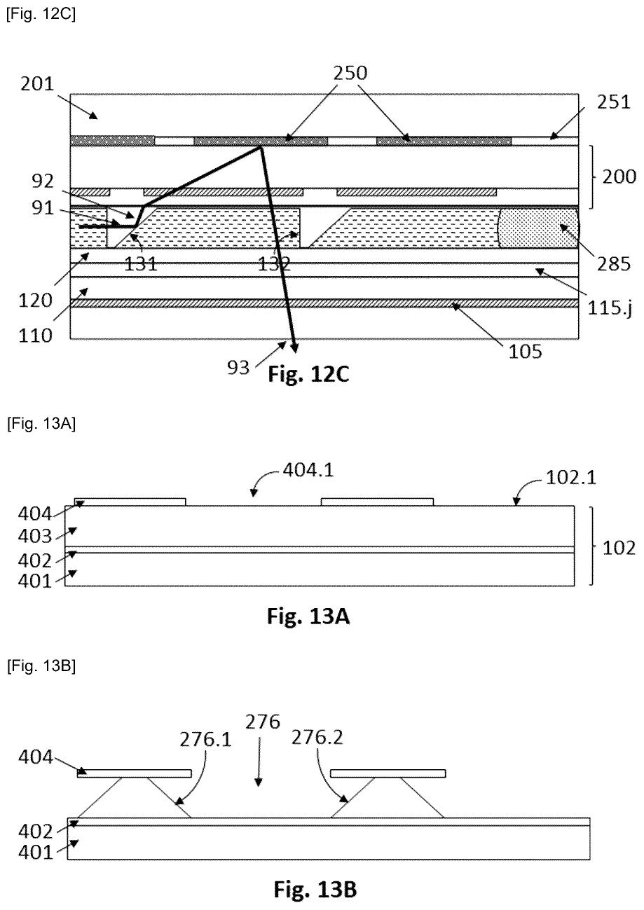

FIGS. 12A to 12C are schematic cross-section views of steps of the method for manufacturing the example display device;

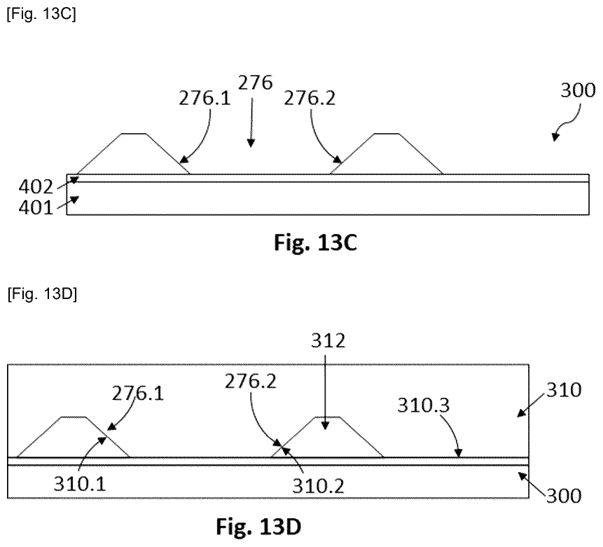

FIGS. 13A to 13D are schematic cross-section views of a second method for manufacturing the reference mold and the stamp specially designed for implementing the method for manufacturing the example display device.

### DETAILED DISCLOSURE OF PARTICULAR EMBODIMENTS

In the figures and in the following description, the same references represent identical or similar elements. In addition, the different elements are not represented to scale so as to favor clarity of the figures. Moreover, the different embodiments and alternatives are not mutually exclusive and could be combined together. Unless stated otherwise, the terms “substantially”, “about”, “in the order of” mean to within 10%, and preferably to within 5%. Moreover, the terms “between . . . and . . . ” and equivalents mean that the bounds are included, unless otherwise stated.

The invention relates to a device for displaying an image. It comprises an illumination module, a set of addressing waveguides, a set of addressing electrodes, and a matrix of extraction structures. Each intersection of an addressing waveguide with an addressing electrode comprises an extraction structure of the matrix. Each addressing waveguide is optically coupled to the illumination module. Addressing waveguides and addressing electrodes extend in parallel to an upper face of a substrate.

Each extraction structure comprises an intermediate waveguide that extends from an input face to an output face. In operation, an electric potential applied to the corresponding addressing electrode acts on the intermediate waveguide so as to increase its refractive index up to a second level for optically coupling an optical mode guided by the addressing waveguide in front of the extraction structure with an optical mode of the intermediate waveguide which is emitted in a beam emitted by the output face. The input faces of all intermediate waveguides have an orientation such that each beam emitted from an extraction structure is reflected into a reflected beam on the input face of the next extraction structure.

The orientation is characterized by an angle γ formed by the input face with the upper face of the substrate and an angle β formed by the optical axis of the addressing waveguide 115.j with the normal to the input face in a sectional plane parallel to the upper face. The addressing electrodes have to be oriented at an angle equal to π/2+β with respect to the optical axes of the addressing waveguides to be able to act on the intermediate waveguides.

In order to achieve the conditions for total reflection on the input face, the emitted beam propagates in a high index region. The refractive index of the high index region is close to the second level to limit a parasitic reflection at the output face, and strictly greater than the refractive index of the intermediate waveguide in the absence of interaction with an addressing electrode. Under these conditions, it is possible to achieve both a total reflection on the input face and to extract the reflected beam from the display device when the angle γ is greater than or equal to 30 degrees and the angle β is adjusted to a strictly positive value inducing a total reflection on the input face.

Advantageously, the display device comprises a matrix of holograms corresponding to the matrix of extraction structures. Each hologram is placed facing an input face of the matrix of extraction structures.

The display device provided with a matrix of holograms is for example a directional microdisplay for which each pixel is configured to emit a directional and diverging pixel beam propagating along a predefined extraction axis. The pixel beam propagates with an angle of divergence with respect to the extraction axis. The divergence angle is predetermined, preferably less than 45° or less than 30°. For example, the angle of divergence is substantially the same for all pixels. The extraction axes may be different from one pixel to another and configured to cover an entrance pupil of an optical system so as to increase light efficacy through the optical system. This embodiment is particularly advantageous when the entrance pupil is small in size and/or intended to be positioned close to the microdisplay, in order to obtain a compact optical system, as is necessary in “near-eye” optical systems.

Throughout the description, two optical components are said to be optically coupled if an optical mode can at least partly propagate in the two optical components, optionally via intermediate optical components. The coupling can be done in various ways, for example via direct coupling, a diffraction grating, a power divider, adiabatic or evanescent or directional coupling, etc.

Two guided optical modes are said to be optically coupled when the power of one is derived entirely from the power of the other, without intermediate conversion into another form of energy.

Layer means here, and for the remainder of the description, an extent consisting of one or more sublayers of a material, the thickness of which along an axis z is less than, for example ten times or even twenty times, its longitudinal width and length dimensions in a plane (x, y) perpendicular to the axis z. A layer may be structured. When it consists of a plurality of sub-layers, the sub-layers may be made from different materials. The sublayer or sublayers extend in planes substantially parallel to the plane (x, y).

A layer or element is considered transparent for a given light spectrum if the layer or element transmits at least 50% of a light flux of interest included in the light spectrum.

Particular embodiments will be described relating to a device for displaying an image consisting of a set of pixels, preferably arranged as a matrix. However, these embodiments may be adapted to other optoelectronic devices, for example a microdisplay utilizing an autofocus effect or an Optical Phase Array (OPA).

In operation, the display device 1 displays the image in a wavelength spectrum hereinafter called display spectrum. It comprises a substrate 100, an illumination module 51, and a set of addressing waveguides 115.j (FIG. 1A). The substrate 100 comprises an upper face. The addressing waveguides 115.j are parallel to each other. They rest on the upper face so that they are parallel thereto.

Herein and for the remainder of the description, an orthogonal three-dimensional direct reference frame (xi, yi, z) is defined, where the axes xi and yi form a plane parallel to the upper face of the substrate 100, the axis xi being oriented in parallel to the addressing waveguides 115.j, and wherein the axis z is oriented substantially orthogonal to the upper face of the substrate 100, from the upper face to the set of addressing waveguides 115.j. In the remainder of the description, the terms “vertical” and “vertically” are understood to be relative to an orientation substantially parallel to the axis z, and the terms “horizontal” and “horizontally” as being relative to an orientation substantially parallel to the plane (xi, yi). Furthermore, the terms “lower” and “upper” are defined as relating to an increasing position when moving away from the substrate 100 in the +z direction. The term “lateral” refers to an orientation substantially parallel to the axis z.

The illumination module 51 comprises a number Ni greater than or equal to 1 of light sources 53. The light sources 53 emit in the display spectrum, for example in the visible spectrum. Each light source may be a laser or a light emitting diode. Advantageously, it has low temporal coherence. Here, each light source 53 is a Superluminescent Light Emitting Diode (SLED).

The set of addressing waveguides 115.j is optically coupled to the illumination module 51. That is, in operation, for each addressing waveguide 115.j, an optical mode derived from the illumination module 51 is guided in the addressing waveguide 115.j from an input of the addressing waveguide 115.j. The axis xi is oriented in parallel to the addressing waveguide 115.j in the propagation direction of the guided optical mode. In this example, the display device 1 further comprises one or more optional power dividers 114. Each addressing waveguide 115.j is optically coupled to a light source 53 via a power divider 114 and an input waveguide 112 of the display device 1. Preferably, each addressing waveguide 115.j is optically coupled to a single corresponding light source 53. The addressing waveguide 115.j, the power divider 114 and the input waveguide 112 are made of transparent materials at an emission wavelength of the corresponding light source 53, for example of silicon nitride.

Each power divider 114 has an input and a number N_{g} of outputs, strictly greater than 1. Each input waveguide 112 extends from an input of a power divider 114 to a light source 53. Each addressing waveguide 115.j is optically coupled to an output of a power divider 114. Each power divider 114 is configured to equally distribute the power of an incident optical mode, at the input of the power divider 114, into optical modes, each guided by an addressing waveguide 115.j optically coupled to an output of the power divider 114. The incident optical mode is guided by an input waveguide 112 from a corresponding light source 53. Each power divider may comprise one or more directional couplers and/or one or more multi-mode interferometric couplers (or MMI, for Multi-Mode Interferometer) and/or one or more Y-junctions.

In this example, all the power dividers 114 have the same number of outputs N_{g}. Each power divider 114 gathers a number N_{g} of adjacent addressing waveguides 115.j corresponding to a image display area. The display areas are contiguous. Thus, the set of addressing waveguides 115.j consists of N_{g}*Nₗ addressing waveguides 115.j, numbered from 115.l to 115.p along the axis yi. To avoid overloading the figures, N_{g} was chosen equal to 10. The number Nₗ of display zones and light sources 53 was limited to 6. The total number of addressing waveguides 115.j is thus equal to 60.

Here, each addressing waveguide 115.j of the set comprises a rectilinear portion along a direction xa parallel to xi, and with the same orientation as xi. The set of rectilinear portions form a periodic array with a period p along the axis yi. The addressing waveguides 115.j are single-mode guides. They can be of any type, such as for example ridge guides, or as here, strip guides. The period p is large enough for two adjacent addressing waveguides 115.j not to be optically coupled to each other. The period p is chosen with respect to an area footprint of the display device 1 to be respected, for example for the purpose of integrating it into an optical system, or to be able to be formed with photolithography tools of the semiconductor industry. The period p is for example between 1 μm and 10 μm, for example equal to 4 μm.

The display device 1 further comprises a matrix of extraction structures 61.i.j and a set of addressing electrodes 205.i, the latter being represented by hatched polygons in FIG. 1B. Each extraction structure 61.i.j of the matrix is arranged at an intersection of an addressing waveguide 115.j and an addressing electrode 205.i, as represented in the cross-section view of FIG. 2A. In operation, an addressing electrode 205.i, when biased, acts on the opposite extraction structures 61.i.j to at least partly extract the optical modes guided by the corresponding addressing waveguides 115.j. An extraction rate is defined for each extraction structure 61.i.j as being equal to the ratio of the intensity of the light extracted by the extraction structure 61.i.j, to the intensity of the corresponding guided optical mode. In the description, any characteristic described in connection with a particular extraction structure 61.i.j is common to all extraction structures 61.i.j of the matrix, unless expressly otherwise stated. Similarly, any particular arrangement of a particular element of an extraction structure 61.i.j with another element of the display device 1 applies to all extraction structures 61.i.j of the matrix, unless expressly stated otherwise.

Each addressing waveguide 115.j herein comprises a distinct optical modulator 52 arranged between the illumination module 51 and the matrix of extraction structures 61.i.j. The optical modulator 52 is able to modify the intensity of an optical mode guided by the addressing waveguide 115.j when passing. For example, it is capable of modifying intensity of the guided optical mode over a set or a range of predetermined values, possibly extending up to the complete extinguishment of the guided mode. It may be of any known type, for example a Mach-Zehnder modulator or an electro-absorption modulator. In this example, each optical modulator 52 is arranged between a power divider 114 and the matrix of extraction structures 61.i.j.

The display device 1 further comprises a modulation circuit 56 electrically coupled to each optical modulator 52. In operation, the modulation circuit 56 controls each optical modulator 52 so that the intensity of the guided optical mode is equal to a value of the range or set of predetermined values.

The addressing electrodes 205.i are made of one or more electrically conductive materials, for example metal or a metal oxide, such as Indium Tin Oxide (ITO) or Aluminum-doped Zinc Oxide (AZO). Preferably, the addressing electrodes 205.i are transparent in the display spectrum. They extend in parallel to the upper face of the substrate 100, and in parallel to an axis ya of the plane (xi, yi), forming an angle β with the axis yi. They are numbered from 205.1 to 205.n from one corner to the other of the matrix of extraction structures 61.i.j.

The common characteristics of the extraction structures 61.i.j of the matrix are represented in more detail in FIGS. 2A, 2B and 2C. FIG. 2A is a schematic vertical cross-section view including an optical axis of the addressing waveguide 115.j, at detail A of FIG. 1B. FIG. 2B shows a detail in FIG. 2A. And FIG. 2C is a schematic perspective view of some elements of detail A of FIG. 1B. FIG. 2A shows the extraction structure 61.i.j, surrounded by the previous extraction structure 61.i−1.j and the next extraction structure 61.i+1.j in order of appearance along the addressing waveguide 115.j along the direction +xi. The extraction structures 61.i−1.j, 61.i.j and 61.i+1.j are located respectively at the intersections of the addressing electrodes 205.i−1, 205.i and 205.i+1 with the addressing waveguide 115.j.

In FIG. 2A, elements of the display device 1 not visible in FIGS. 1A and 1B are represented, namely a common electrode 105, a lower encapsulation layer 110, an upper encapsulation layer 120, a structured layer 270 and a cover 200.

The common electrode 105 herein rests on the upper face of the support substrate 100, optionally separated therefrom by one or more layers, for example an electrically insulating layer. The common electrode 105 is of an electrically conductive material, for example a metal or, a metal oxide, such as indium tin oxide (ITO) or aluminum-doped zinc oxide (AZO). It has a portion facing each extraction structure 61.i.j, preferably continuously extending under the entire matrix of extraction structures 61.i.j.

The addressing waveguide 115.j is separated from the common electrode 105 by the lower encapsulation layer 110. The lower encapsulation layer 110 is in physical contact with the common electrode 105 and the addressing waveguide 115.j. It is made of one or more dielectric materials transparent in the display spectrum. The dielectric material(s) have refractive indices strictly lower than a refractive index of the addressing waveguide 115.j. Here, the lower encapsulation layer 110 is of silicon oxide. It has a thickness of between 100 nm and 2 μm, preferably equal to 1 μm.

The extraction structure 61.i.j comprises an intermediate waveguide 130 and a high index region 260. The intermediate waveguide 130 is separated from the addressing waveguide 115.j by the upper encapsulation layer 120. It extends in parallel to the upper face of the support substrate 100 from an input face 131 to an output face 132. It comprises a liquid crystal. The input face 131 and the output face 132 are facing the addressing waveguide 115.j. The input face 131 forms an angle γ with the upper encapsulation layer 120, the upper substrate face 100 and the plane (xi, yi). It is parallel to the axis ya. It therefore forms an angle equal to the angle β with respect to the axis yi. The output face 132 is advantageously parallel to the axis ya.

According to a first possible embodiment of the extraction structure 61.i.j represented in FIG. 2A, the output face 132 is substantially orthogonal to the upper face of the substrate 100. According to a second possible embodiment of the extraction structure 61.i.j represented in FIG. 3, the output face 132 forms an angle strictly less than 90 degrees with the upper encapsulation layer 120, the upper face of the substrate 100 and the plane (xi, yi). When each output face 132 is symmetrical of a corresponding input face 131 with respect to a plane parallel to the plane (ya, z), the display device 1 is functional for another optical mode guided by the addressing waveguide 115.j propagating in the opposite direction.

The upper encapsulation layer 120 is in contact with the addressing waveguide 115.j and the intermediate waveguide 130 of each extraction structure 61.i.j of the matrix. It is made of one or more dielectric materials transparent in the display spectrum. The dielectric material(s) have refractive indices strictly lower than a refractive index of the addressing waveguide 115.j and the extraordinary refractive index (ne) of the liquid crystal. Preferably, the refractive index(ces) of the dielectric material(s) is greater than or equal to the ordinary refractive index (no) of the liquid crystal and less than or equal to 1.1 times the ordinary refractive index (no) of the liquid crystal. Herein, the upper encapsulation layer 120 is of silicon nitride. For example, it has a thickness of between 10 nm and 200 nm, measured in vertical alignment with the addressing waveguide 115.j.

For example, the liquid crystal has a nematic phase. It has an ordinary refractive index (no) and an extraordinary refractive index (ne). The ordinary refractive index (no) is the refractive index affecting a light wave propagating in the liquid crystal, linearly polarized along a direction perpendicular to the mean orientation of the electric dipoles of the molecules of the liquid crystal. The extraordinary refractive index (ne) is the refractive index affecting a light wave propagating in the liquid crystal, linearly polarized along a direction parallel to the mean orientation of the electric dipoles of the molecules of the liquid crystal. By “orientation of the molecules of a liquid crystal”, it is meant the mean orientation of the electric dipoles of the molecules of the liquid crystal having an electric dipole. In the absence of an electric field in the liquid crystal, one or more anchor layers, not represented in the figures, orient the molecules of the liquid crystal along a predominant, even called favored, direction.

The liquid crystal is for example a 5CB liquid crystal (4′-pentyl-4-biphenylcarbonitrile or 4-cyano-4′-pentylbiphenyl or 4-pentyl-4′-cyanobiphenyl). For example, the ordinary refractive index (no) equals 1.542 and the extraordinary refractive index (ne) equals 1.735 for a wavelength λ equal to 532 nm.

The addressing electrodes 205.i are arranged in the cover 200. The addressing waveguide 115.j and the intermediate waveguide 130 of the extraction structure 61.i.j are interposed between the common electrode 105 and the addressing electrode 205.i. The addressing electrode 205.i is in front of the intermediate waveguide 130 and in front of the common electrode 105. It is located at a distance dₑₛ, preferably not zero, from the intermediate waveguide 130. The distance dₑₛ is for example between 100 nm and 2 μm, for example equal to 1 μm. The distance dₑₛ is a distance common to all extraction structures 61.i.j of the matrix.

The heights of the intermediate waveguides 130 measured along the axis z are equal to a common height H_{g}. Advantageously, the common height is optimized by simulation to maximize extraction rate of the extraction structures 61.i.j. In this example, the common height H_{g} is between 500 nm and 5 μm preferably substantially equal to 1.5 μm, for a display spectrum included in the visible spectrum, and a height of the addressing waveguides 115.j between 50 nm and 300 nm, preferably substantially equal to 150 nm.

The cover 200 is transparent in the display spectrum. For example, it is of quartz or glass or a polymer. It may optionally comprise transparent layers in the display spectrum, such as for example one or more layers of silicon oxide or silicon nitride. The cover 200 rests on the intermediate waveguides 130 of all extraction structures 61.i.j, on a side opposite to the common electrode 105, for example in physical contact therewith or, as represented herein, separated therefrom by a portion of the structured layer 270 in physical contact with the intermediate waveguides 130 and the cover 200. If the portion has a refractive index greater than or equal to the extraordinary refractive index (ne) of the liquid crystal, the portion of the material preferably has a thickness less than 20 nm, or even less than 10 nm. The cover 200 has a refractive index nᵥ strictly less than the extraordinary refractive index (ne) over an entire lower region of the cover 200 extending from the addressing electrodes 205.i to a lower face of the cover 200.

The high index region 260 extends from the output face 132 of the intermediate waveguide 130, to the input face 131 of the next extraction structure 61.i+1.j. It has a refractive index nₚ strictly greater than the ordinary refractive index (no) of the liquid crystal. In this example, the high index region 260 is a part of the structured layer 270. The latter rests on the upper encapsulation layer 120 and encapsulates the intermediate waveguides 130 of all the extraction structures 61.i.j. The structured layer 270 is in contact with the entire input face 131, the entire output face 132 of each extraction structure 61.i.j, and optionally with the upper encapsulation layer 120, as is represented herein. The refractive index of the high index region 260 is for example between 1.5 and 2. Preferably, the difference between nₚ and the extraordinary refractive index (ne) of the liquid crystal is less than or equal to 0.2 in absolute value, preferably less than or equal to 0.05 in absolute value.

The input face 131 of the next extraction structure 61.i+1.j is located at a distance eₚ from the output face 132, measured in parallel to the plane (xi, yi). eₚ is the smallest distance separating the input face 131 from the output face 132 in a horizontal plane. The distance eₚ is for example less than 20 nm, preferably less than 10 nm, advantageously the smallest possible, it being understood that it may be zero.

The input faces 131 of all intermediate waveguides 130 facing an addressing electrode 205.i are preferably coplanar. The output faces 132 of all intermediate waveguides 130 facing an addressing electrode 205.i are also preferably coplanar. This is the case in this example, since for each addressing electrode 205.i, the intermediate waveguides 130 facing the addressing electrode 205.i are portions of a common planar waveguide 135, represented in FIG. 2C.

In this example, when an extraction structure 61.i.j is preceded by another, the input face 131 of its intermediate waveguide 130 is placed at a distance L_{C} from the input face 131 of the intermediate waveguide 130 of the previous extraction structure 61.i−1.j. Thus, the matrix of light extraction structures 61.i.j is periodic with a period L_{C} along the axis xa; and when the addressing waveguides 115.j comprise periodic rectilinear portions with a period p, pixels of the image are arranged in an orthogonal matrix according to pitches

$${d}_{1} = \frac{p}{cos β}$$

and, d₂=L_{C} cos β, respectively along ya and an axis of the matrix orthogonal to ya. L_{C} defines a coupling length between the intermediate waveguide 130 and the addressing waveguide 115.j.

The period L_{C} is chosen to be large enough to obtain an extraction rate greater than or equal to 50%, or even greater than or equal to 80%, or better greater than or equal to 90%. Here, L_{C} is between 10 μm and 30 μm, preferably between 20 μm and 25 μm.

An example of operation of an extraction structure 61.i.j will now be described. A polarized optical mode of the Magnetic Transverse (MT) type and with a wavelength λ belonging to the display spectrum is guided along the axis +xa by the addressing waveguide 115.j toward the input face 131 of the intermediate waveguide 130. A non-zero potential difference is applied between the common electrode 105 and the addressing electrode 205.i so as to create an electric field sufficient to orient molecules of the liquid crystal in parallel to the electric field. With the addressing electrode 205.i and the common electrode 105 facing each other and facing the intermediate waveguide 130, the electric field is substantially parallel to the axis z in a substantial part of the intermediate waveguide 130 defining a coupling portion of the intermediate waveguide 130. The molecules of the liquid crystal are therefore mostly oriented in parallel to the axis z in the coupling portion, which is the direction of polarization of the guided optical mode.

The operating mode described here is only an example in accordance with the figures. Alternatively, the extraction structure 61.i.j may also be able to extract an Electrical Transverse (ET) type polarized guided mode when a zero or non-zero potential difference is applied between the common electrode 105 and the addressing electrode 205.i. The extraction structure 61.i.j may also be able to extract a Magnetic Transverse (MT) type polarized optical mode when the common electrode 105 and the addressing electrode 205.i are at the same potential. For some of these alternatives within the grasp of a person skilled in the art, it is necessary to modify arrangement of the common electrode 105 and the addressing electrode 205.i with respect to the intermediate waveguide 130 and/or orientation of an extraordinary axis of the liquid crystal in the absence of an electric field in the liquid crystal.

The thickness of the upper encapsulation layer 120 is thin enough for an evanescent part of the guided optical mode to interact with the coupling portion. Due to the orientation of the molecules parallel to the direction of polarization of the guided mode, the refractive index of the coupling portion allows a mode excited by the evanescent part to propagate in the intermediate waveguide 130, i.e. the propagation constants of the excited mode and the guided optical mode are substantially equal in the coupling portion. Thus, part of the guided optical mode is optically coupled to the intermediate waveguide 130 by evanescent coupling and exits through the output face 132 to generate an emitted beam 91. The extracted light involved in the definition of the extraction rate (see above) corresponds to the emitted beam 91. Thus, the extraction rate is equal to the ratio of the intensity of the emitted beam 91 to the intensity of the guided optical mode. Advantageously, the difference in absolute value between nₚ and the extraordinary refractive index (ne) is minimized to reduce reflection of the emitted beam 91 on the output face 132 and/or minimize deflection of the emitted beam 91 when passing the output face 132 and/or minimize a diffraction phenomenon of the evanescent part of the guided optical mode on the input face 131.

The emitted beam 91 propagates in free space in the high index region 260 along a main axis until it reaches the input face 131 of the next extraction structure 61.i+1.j. The main axis forms an angle α with a normal to the input face 131 greater than or equal to a minimum incidence angle on the surface of the input face 131 for which light is totally reflected, as is represented in the optical diagram of FIG. 4. Only the input face 131 of the next extraction structure 61.i+1.j has been represented in FIG. 4. Points A, B, C, D, E and F are construction points depicting passage of a light ray in the vicinity of the input face 131 with respect thereto. Point D is for example a point located at an interface between the cover 200 and the structured layer 270. Augie α is equal to

$$\frac{π}{2} - arcsin ( cos β sin γ ) .$$

It therefore increases as a function of β. When γ is equal to 45 degrees, φ is equal to β.

Thus, the emitted beam 91 is reflected by total internal reflection on the input face 131 of the next extraction structure 61.i+1.j into a reflected beam 92. The reflected beam 92 propagates in free space in the high index region 260 along a direction forming, with the normal to the input face 131, an angle equal to the angle α, and an angle φ with a normal to the upper face of the substrate 100 and to a lower face of the cover 200. The angle φ can be determined by a ray tracing model.

Conversely, when a zero potential difference is applied between the common electrode 105 and the addressing electrode 205.i, the electric field is substantially zero inside the liquid crystal. The molecules of the liquid crystal are therefore mostly oriented in parallel to a favored direction by one or more anchor layers, parallel to the plane (xi, yi), here parallel to the axis xa. Due to this orientation of the molecules, the guided optical mode interacts with a medium having refractive index equal to the ordinary refractive index (no) in the coupling portion and no mode of the intermediate waveguide 130 is excited, nor guided. Thus, the guided optical mode remains confined in the addressing waveguide 115.j.

Dimensioning of the extraction structures 61.i.j and the addressing waveguides 115.j, as well as their relative positionings, can be optimized using electromagnetic wave propagation simulation tools implementing algorithms such as FDTD (Finite Difference Time Domain), FDE (Finite Difference Eigenmode) or EME (Eigen Mode Expansion). The behavior of the liquid crystal, and therefore its refractive index, when applying a potential difference between the common electrode 105 and the addressing electrode 205.i, can be deduced from simulation results obtained by a finite element method, such as that provided by the commercially available COMSOL® software.

FIG. 5A is a graph giving values of α (curve C1, in degrees) and φ (curve C2, in degrees) as a function of β (axis of abscissae in degrees), for an angle γ equal to 54.74 degrees. Curve C3 shows the angular limit beyond which the reflection is total on the input face for nₚ equal to 1.735 and an ordinary refractive index of the liquid crystal equal to 1.542. Thus, in this particular case, the angle β should be greater than or equal to 56.2 degrees for the emitted beam 91 to be integrally reflected on the input face 131 (intersection point of curves C1 and C3). The angle φ is therefore greater than or equal to 58.5 degrees (value of φ for an angle β corresponding to the intersection point of curves C1 and C3).

FIG. 5B is a graph giving the values of α (curve C11, in degrees) and ¢ (curve C12, in degrees) as a function of β (axis of abscisse in degrees), for an angle γ equal to 45 degrees. Curve C13 shows the angular limit beyond which the reflection is total on the input face for nₚ equal to 1.735 and an ordinary refractive index of the liquid crystal equal to 1.542. Thus, in this particular case, the angle β should be greater than or equal to 50.2 degrees for the emitted beam 91 to be integrally reflected on the input face 131 (intersection point of curves C11 and C13). The angle φ is therefore greater than or equal to 50.2 degrees (value of φ for an angle β corresponding to the intersection point of curves C11 and C13).

FIG. 5C is a graph giving the values of φ (axis of ordinates in degrees), as a function of β (axis of abscissae in degrees) for an angle γ equal to 45 degrees (curve C21), equal to 30 degrees or 60 degrees (curve C22), equal to 15 degrees or 75 degrees (curve C23). Curve C24 shows the angular limit beyond which the reflection is total on the lower face of the cover 200 for nᵥ equal to 1.5. Thus, for this particular cover 200 and an angle γ equal to 45 degrees, an angle β between 44.8 degrees and 59.8 degrees makes it possible to obtain a reflected beam 92 which is transmitted to a cover 200 with a refractive index nᵥ equal to 1.5. This result is achieved for an angle β between 52 degrees and 57.7 degrees, when γ is 54.74 degrees. The reflected beam 92 forms an angle φ, with a normal to the lower face of the cover 200 equal to arcsin

$$( \frac{{n}_{p}}{{n}_{v}} sin ( ϕ ) ) .$$

The cover 200 further comprises an upper face opposite to the lower face of the cover 200. The lower and upper faces of the cover 200 are planar and parallel to each other. The angle φᵥ is therefore also the angle that the reflected beam 92 forms with the upper face when it reaches it. By way of example, in the conditions of FIG. 5B, when nᵥ is equal to 1.5 and β is equal to 50.2 degrees, the angle φᵥ is equal to 62.7 degrees. The refractive index of the medium surrounding the upper face of the cover 200 should be sufficiently high for the reflected beam 92 to be extracted from the display device 1 via the upper face of the cover 200 into a pixel beam 93, as represented in FIG. 12B.

Optionally, each extraction structure 61.i.j further comprises a hologram 250 facing the input face 131 of the next extraction structure 61.i+1.j. The set of holograms 250 is therefore arranged as a matrix in the same way as the matrix of extraction structures 61.i.j. Each hologram 250 is configured to deflect the reflected beam 92 so as to reduce a propagation angle in the cover 200 of the reflected beam 92 relative to a normal to a main plane of the cover. Herein, as the lower and upper faces of the cover 200 are parallel, the propagation angle is equal to o, before the reflected beam 92 reaches the hologram 250. The hologram 250 may be a transmission hologram. Advantageously, as represented in FIG. 12C, it is a reflection hologram. After the hologram 250, the reflected beam 92 propagates in the cover 200 along a direction forming an angle φ′ᵥ with the normal to the main plane and to the lower and upper faces of the cover. The angle φ′ᵥ is small enough to extract the reflected beam 92 from the display device 1 into a pixel beam 93, either via the upper face of the cover 200 when the hologram 250 is a transmission hologram, or via the substrate 100 when the hologram 250 is a reflection hologram.

According to a particular embodiment of the display device 1, each hologram 250 deflects the reflected beam 92 so as to extract the reflected beam 92 from the display device 1 into the pixel beam 93 along a predefined extraction axis and an also predefined divergence angle so that the display device 1 is a directional micro-screen, for example adapted to a “near-eye” optical system.

An example of operation of the display device 1 is illustrated in FIG. 6. In this figure, the display device 1 is represented at a given instant t during which 4 addressing electrodes 205.i (in uniform gray in the figure) have been activated by applying an electric potential difference between each of these active addressing electrodes 205.i and the common electrode 105 by an addressing circuit 54 of the display device 1. The common electrode 105 may be connected by the addressing circuit 54 to a fixed electric potential, for example to ground.

The difference in electric potential switches the refractive index of the liquid crystal for the direction of polarization of the optical modes guided by the addressing waveguides 115.j, from a first level to a second level strictly greater than the first level. The first and second levels are here equal to the ordinary refractive index and the extraordinary refractive index of the liquid crystal, respectively. Thus, the optical modes guided by the addressing waveguides 115.j intersecting the active addressing electrodes 205.i are coupled by evanescent coupling to the intermediate waveguides 130 of respective extraction structures 61.i.j located at an intersection of an addressing waveguide 115.j and an active addressing electrode 205.i.

The other addressing electrodes 205.i are inactive (hatched in FIG. 6), i.e. they are maintained at the same electric potential as the common electrode 105 by the addressing circuit 54. The molecules of the liquid crystal of the corresponding intermediate waveguides 130 are therefore oriented along the favored direction. The refractive index of the liquid crystal for the direction of polarization of the optical modes guided by the addressing waveguides 115.j is thus equal to the first level, here equal to the ordinary refractive index. The optical modes guided by the addressing waveguides 115.j are then not coupled to the intermediate waveguides 130 of the extraction structures 61.i.j intersecting the inactive addressing electrodes 205.i.

By way of illustration, the display device 1 herein displays, at instant t, 8 pixels of the image for an active addressing electrode 205.i. 9 pixels for another active addressing electrode 205.i and none for the two remaining addressing electrodes 205.i. The displayed pixels are represented by solid squares. Intensities of the corresponding pixel beams 93 are schematically represented in gray levels, a darker gray level corresponding to a higher intensity. The modulation circuit 56 controls the optical modulators 52 of all addressing waveguides 115.j intersecting the active addressing electrodes 205.i, so as to set intensities of the pixel beams 93 to values corresponding to respective gray levels of the image. In this example, some guided optical modes have substantially zero intensity. Advantageously, the display device 1 further comprises a power supply circuit of the illumination module 51 configured to switch off power supply to each light source 53 corresponding to a display area comprising only pixels to be displayed in black at instant t. The power supply circuit can further be configured to set an emission level of each light source 53 according to the gray level of the brightest pixel of the image to be displayed in the display area optically coupled to the light source 53, so that intensity of the guided optical mode corresponding to the brightest pixel of the display area is not modulated by the corresponding optical modulator 52. Thus, power consumption of the display device 1 is minimized.

In FIG. 6, a direction of scanning the set of addressing electrodes 205.i imposed by the addressing circuit 54 has been represented by arrows. The set of addressing electrodes 205.i is herein divided into contiguous addressing zones, each consisting of a group of adjacent addressing electrodes 205.i. In this example, all addressing zones have the same number of addressing electrodes 205.i, here equal to 8. The addressing circuit 54 is configured to sequentially bias along the scanning direction, one by one, the addressing electrodes 205.i of each addressing zone so as to switch the refractive index of the liquid crystal of the intermediate waveguides 130 facing the second level. In this example, as is represented in FIG. 6, the addressing circuit 54 simultaneously bias an addressing electrode 205.i of each addressing zone, i.e. it scans all the addressing zones at the same time, here according to the same sequence. The scan is fast enough for a viewer to perceive the image by virtue of a persistence of vision effect.

The addressing electrodes 205.i are arranged such that each pair of addressing electrodes 205.i simultaneously biased and belonging to contiguous addressing zones, activate two extraction structures 61.i.j located at two opposite ends of the matrix of extraction structures 61.i.j and facing two adjacent addressing waveguides 115.j. Thus, at any instant t of the display sequence, each addressing waveguide 115.j can display a pixel of the image, i.e. an extraction structure 61.i.j is activated by addressing waveguide 115.j. The power consumption of the display is thus reduced and the display frequency maximized.

FIG. 7 represents an example of an image 42 to be displayed by the display device 1. Image 42 comprises a matrix of square pixels extending along two orthogonal axes, one of which forms an angle equal to the angle β with the addressing waveguides 115.j. This is a particularly advantageous configuration for which d₁ is equal to d₂, achieved when the angle β is equal to

$${β}_{0} = arccos ( \sqrt{\frac{p}{{L}_{C}}} ) .$$

For example, it is possible to choose L_{C} to achieve an extraction rate of 90%, and a period p such β₀ is within a range of values allowing the emitted beam 91 to reflect itself into a reflected beam 92 on the input face 131 and optionally transmit the reflected beam 92 to a cover 200. Table 1 shows an example of parameterizing the display device 1 to achieve this result.

TABLE 1

| Parameter | Value |
|---|---|
| no | 1.542 |
| ne | 1.732 |
| np | 1.7 |
| nv | 1.5 |
| γ | 45° |
| p | 7 μm |
| L_{C} | 21 μm |
| β | 55° |
| d₁, d₂ | 12 μm |

The image 42 to be displayed can be obtained from the standard image 41 of FIG. 7. The standard image 41 comprises a matrix of pixels arranged in an orthonormal grid aligned on the axes xi and yi. For the sake of clarity, the standard image 41 and the image 42 to be displayed have a reduced number of pixels, but they may have any number of pixels. The standard image 41 may correspond to any image standard. For example, it can be a VGA, SVGA, HD, Full HD image, etc.

In the case where the image 42 to be displayed is obtained from the standard image 41, the display device 1 may further comprise an image conversion circuit (not represented) configured to convert the standard image 41 into the image 42 to be displayed. For this, the image conversion circuit can carry out any type of known mathematical and/or image processing, such as for example interpolation, averaging, framing techniques. Advantageously, the matrix of extraction structures 61.i.j has an aspect ratio similar to or identical to the standard image 41. Preferably, the number of extraction structures 61.i.j is equal to the number of pixels of the standard image 41 to within 10%.

The display device 1 obtained with the parameters of Table 1 may for example be used to display a VGA image of 640×480 pixels. Its illumination module 51 may for example comprise 20 light sources 53. A number N_{g} equal to 72 addressing waveguides 115.j optically coupled to a light source 53. The matrix of extraction structures 61.i.j has a footprint of about 10 mm by 7.5 mm.

A display system 10 may comprise several display devices 1 as described in connection with FIGS. 1A, 1B, 2A, 2B, 2C, 3 and 6 arranged one above each other. The pixel beams 93 of each display device 1 are for example extracted from a same side of the display system 10. The display devices 1 may share their addressing circuits 54 and/or their modulation circuits 56 and/or their power supply circuits.

For example, it is possible to superimpose at least 2 display devices 1 to display a color image. Preferably, the display system 10 comprises 3 display devices 1 whose display spectra are within wavelength ranges corresponding to a green, blue and red color respectively. The display devices 1 may comprise a same number of extraction structures 61.i.j, arranged in the same manner. The input faces 131 of the extraction structures 61.i.j of a display device 1 may be aligned to within a constant offset with the input faces 131 of the extraction structures 61.i.j of another display device 1, for example such that the display system 10 is capable of displaying a color image. For example, it is possible to make all the coupling lengths of the 3 display devices equal and to adjust extraction rates of each display device 1 by optimizing one or more dimensions of its addressing waveguides 115.j.

When the display spectra of the display devices 1 are different, one or more display devices 1 of the display system 10 may comprise a matrix of holograms 250 since the holograms 250 are inherently wavelength selective. The pixel beams 93 of a display device 1 can then be extracted from the display device 1 and pass through another superimposed display device 1 comprising a matrix of holograms 250 before being extracted from the display system 10.

A second example of display system 10 is represented in FIGS. 8A, 8B and 8C. FIGS. 8B and 8C are respectively top views of the details B and C in FIG. 8A.

In these figures, the display system 10 comprises a first and a second display device 1 as described in connection with FIGS. 1A, 1B, 2A, 2B, 2C, 3 and 6. The respective sets of addressing waveguides 115.j. 115.l of the first and second display devices 1 are interlaced in a display plane of the display system 10. The substrates 100 of the first and second display devices 1 are identical and consist of a common substrate 100. The display plane is parallel to the upper face of the substrate 100. Each addressing electrode 205.i of the first display device 1 is an addressing electrode 205.k of the second display device 1.

The addressing waveguides 115.j. 115.l of the first and second display devices 1 comprise rectilinear portions. The rectilinear portions, the matrix of extraction structures 61.k.l, and the addressing electrodes 205.k of the second display device 1 respectively superimpose on the rectilinear portions, the matrix of extraction structures 61.i.j, and the addressing electrodes 205.i of the first display device 1 by a 180-degree rotation about an axis parallel to the axis z, followed by a translation. Thus, the rectilinear portions of the second display device 1 are oriented along a direction x′a opposite to the direction xa, and here positioned equidistant from the rectilinear portions of the first device. The addressing electrodes 205.k of the second display device 1 are oriented in a direction y′a opposite to the direction ya. The extraction structures 61.i.j, 61.k.l of the first and second display devices 1 comply with the second possibility of FIG. 3.

The addressing circuits 54 of the first and second display devices 1 may be a common addressing circuit 54, as represented herein. In operation, an addressing electrode 205.i, 205.k+1 common to the first and second display devices 1 may be activated to optically couple addressing waveguides 115.j, 115.l belonging to the first and second display device 1 to intermediate waveguides 130 of corresponding extraction structures 61.i.j, 61.k+1.l, belonging to the first and second display device 1. The display system 10 is for example configured to display a better-resolved image by combining the images displayed by the first and second display devices 1, each displaying a distinct half of the pixels of the better-resolved image.

FIG. 8C represents an advantageous arrangement for interrupting the addressing waveguides 115.j. 115.j+1, 115.l, 115.l+1 to make room for optical modulators 52, without risking parasitic light emission and/or unwanted back reflection of the light into the addressing waveguides 115.j, 115.j+1, 115.l, 115.l+1. The arrangement may also be useful to the display device 1 described in connection with FIGS. 1A, 1B, 2A, 2B, 2C, 3 and 6.

The addressing waveguides 115.l of the second display device 1 herein each have an end opposite to the illumination module 51. The end comprises a diffraction grating 117 configured to extract, preferably entirely, an optical mode guided by the corresponding addressing waveguide 115.l, toward an absorber 118. The absorber 118 can be an opaque or absorbent layer, for example an absorbent polymer. When the first and second display devices 1 comprise a common cover 200, or a common support plate 201 as introduced hereinafter, the absorber 118 can be arranged on the cover 200 or on the support plate 201.

The second example of display system 10 can be superimposed on one or more display devices 1 as described in connection with FIGS. 1A, 1B, 2A, 2B, 2C, 3 and 6; and/or on another display system 10 according to the second example. Alternatively, the first and second display device 1 can share their addressing waveguides 115.j, 115.l, i.e. each addressing waveguide 115.j of the first display device 1 is an addressing waveguide 115.l of the second display device 1, and vice versa.

An example method for making a display device 1 as illustrated in FIG. 1B is now described. This method comprises manufacturing an upper part 103 of the display device 1 (FIGS. 10A to 10C) and actually manufacturing the display device 1 integrating the upper part 103 (FIGS. 12A to 12C).

In FIG. 10A, a cover 200 is provided. For this step, it is possible to deposit an electrically conductive layer onto an upper face of a support 600. The support 600 is, in this example, of a material transparent in the display spectrum. For example, it may be of quartz or glass or of a polymer.

The electrically conductive layer may be a metal, or a metal oxide, such as for example an indium tin oxide (ITO). It is etched locally over its entire thickness to make the addressing electrodes 205.i.

An encapsulation layer 610 is formed on the support 600, so as to be in contact with the addressing electrodes 205.i and with the upper face of the support 600. The encapsulation layer 610 has, on a side opposite to the addressing electrodes 205.i, a planar face substantially parallel to the upper face of the support 600. The encapsulation layer 610 is of a material transparent in the display spectrum. For example, it is made of a same material as the support 600. Herein it is of silicon oxide. The support 600 and the encapsulation layer 610 together define the cover 200.

The structured layer 270 is then formed on the cover 200 by a nanoimprint lithography (NIL) method. For this, a film 315 is deposited onto the encapsulation layer 610, in contact with a face of the encapsulation layer 610 opposite to the support 600. The film 315 has a high refractive index strictly greater than the ordinary refractive index of the liquid crystal, for example equal to the extraordinary refractive index of the liquid crystal plus or minus 0.05. It can be greater than or equal to the extraordinary refractive index. It may be a xerogel, or advantageously, a film of UV-curable adhesive, for example a commercially available optical adhesive such as that distributed by Norland®, under the reference NOA 170.

In FIG. 10B, the film 315 is then molded by a soft stamp 310. During this step, the stamp 310 is brought into contact with the film 315 and a pressure exerted on the stamp 310, perpendicular to the upper face of the support 600 is applied, until possibly bringing the stamp 310 into contact with the encapsulation layer 610.

The stamp 310 can advantageously be obtained by the manufacturing method of FIGS. 9A to 9E, or the method of FIGS. 13A to 13D described hereinafter. The stamp 310 comprises a substantially planar bearing face 310.3 and trenches 312 extending deep into the stamp 310 from the bearing face 310.3. When the stamp 310 is not brought into contact with the encapsulation layer 610, the pressure is uniform so as to keep the bearing face 310.3 of the stamp 310 substantially parallel with an upper face of the encapsulation layer 610 opposite to the support 600. Therefore, in all cases, the bearing face 310.3 of the stamp 310 is substantially parallel with the upper face of the encapsulation layer 610 upon shaping the film 315.

In FIG. 10C, the upper part 103 of the display device 1 is obtained. When the film 315 is an UV-curable adhesive, it is lighted by UV radiation holding the stamp 310 in place to cure it. The stamp 310 is then removed. Since the stamp 310 is soft, the UV-curable adhesive does not adhere to the stamp 310 upon removing it. For this sub-step, the stamp 310 is advantageously made of an elastomer such as polydimethylsiloxane (PDMS).

In the alternative for which the film 315 is a xerogel, the stamp 310 is removed, and then the molded film 315 is heated to be crosslinked, and therefore cured.

The film 315 molded and cured constitutes the structured layer 270. It comprises protruding portions 275 each corresponding to a trench 312 of the stamp 310. As the bearing face 310.3 of the stamp 310 is parallel to the upper face of the encapsulation layer 610, ridges of the protruding parts 275 of the structured layer 270 are coplanar and parallel to the upper face of the layer 610. The protruding portions 275 of the structured layer 270 therefore have identical heights, equal to a common height, substantially equal to the height H_{g}.

Each protruding part 275 comprises an inclined face 275.1 corresponding to a first face 310.1 of a trench 312 of the stamp 310, and intended to be an input face 131 of an extraction structure 61.i.j. It also comprises a face 275.2 opposite to the inclined face 275.1, corresponding to a second face 310.2 of the trench 312. The face 275.2 is intended to be the output face 132 of the extraction structure 61.i−1.j preceding the extraction structure 61.i.j.

Alternatively, the structured layer 270 may be formed by gray level lithography.

A polyimide layer (not represented) is then formed in contact with the structured layer 270 between the protruding parts 275, or in contact with the encapsulation layer 610 when the stamp 310 has been brought into contact with it during the nanoimprint lithography step. The polyimide layer is brushed in a direction intended to be a favored direction for the orientation of the molecules of the liquid crystal when no electric fields are present in the liquid crystal. The polyimide layer is thus intended to be an upper anchor layer of the liquid crystal.

In FIG. 12A, a lower part 101 of the display device 1 is provided. The lower part 101 is a photonic chip. It comprises the substrate 100, the common electrode 105, the lower encapsulation layer 110, the set of addressing waveguides 115.j, the upper encapsulation layer 120, and a lower liquid crystal anchor layer (not represented).

Just like the upper anchor layer, the lower anchor layer may be a polyimide layer. It is brushed in a direction intended to be the favored direction for the orientation of the molecules of the liquid crystal when no electric fields are present in the liquid crystal.

An adhesive bead 285 is formed on the lower anchor layer or in contact with the upper encapsulation layer 120. The adhesive bead 285 is closed, i.e. it delimits a central region. It comprises at least one through lateral opening communicating with the central region. The central region may for example have a substantially rectangular shape. Alternatively, the adhesive bead 285 can be formed on the upper part 103.

The upper part 103 of FIG. 10C is then transferred to the upper encapsulation layer 120, so as to bring the protruding portions 275 of the structured layer 270 into contact with the lower anchor layer at the central region. Preferably, all protruding parts are entirely facing the central region. Sufficient pressure may be applied to the upper part 103 to sink the protruding portions into the lower anchor layer, optionally until the protruding portions come into contact with the upper encapsulation layer 120. The adhesive bead 285 attaches the upper part 103 to the lower part 101. The structured layer 270 acts as a spacer setting a gap between the upper encapsulation layer 120 and the cover 200. If the lower and upper parts 101, 103 are rigid, the adhesive bead 285 may be an UV-curable adhesive, for example the same UV-curable adhesive as the film 315. If appropriate, it is lighted by UV radiation so as to attach the upper part 103 to the lower part 101.

In FIG. 12B, a liquid crystal is introduced into the central region via the through lateral opening so as to fill the entire volume delimited by the adhesive bead and the lower and upper anchor layers. The through lateral opening is then sealed.

At the end of this step, a display device 1 is obtained according to a first possibility. Continuous volumes, delimited by the structured layer 270, the upper encapsulation layer 120 and, optionally, the encapsulation layer 610 when the stamp 310 has been brought into contact with the encapsulation layer 610, define the intermediate waveguides 130. Each intermediate waveguide 130 extends between two protruding portions 275 of the structured layer 270. The inclined face 275.1 and the face 275.2 opposite to the inclined face 275.1 of each protruding part 275 respectively constitute the input face 131 of an extraction structure 61.i.j, and the output face 132 of the extraction structure 61.i−1.j preceding the extraction structure 61.i.j.

FIG. 12C is an additional and optional step, aiming to obtain a display device 1 according to the invention comprising the matrix of holograms 250. For this, a holographic film 251 comprising the matrix of holograms 250 is transferred to the cover 200 on one side of the upper part 103 opposite to the lower part 101. The matrix of holograms 250 may be obtained according to the method of FIG. 11. The matrix of holograms is aligned with respect to the matrix of extraction structures 61.i.j so as to place a hologram 250 facing each input face 131 of the matrix of extraction structures 61.i.j.

In FIG. 11, a matrix of holograms 250 is recorded. For this, a holographic film 251 is deposited onto a support plate 201. A plate 360 is brought into contact with the holographic film 251. The plate 360 and the support plate 201 are transparent in the display spectrum. A prism 350 is positioned on the plate 360 on one side of the plate 360 opposite to the holographic film 251. The prism 350 is for example separated from the plate 360 by an immersion liquid 351 for limiting parasitic reflections at the interfaces between the prism 350, the immersion liquid 351 and the plate 360. The immersion liquid 351 also makes it possible to move the prism 350 without friction during recording of the matrix of holograms 250. The support plate 201 and the plate 360 each have opposite faces being planar and parallel to each other.

The prism 350 is of a material transparent in the display spectrum. It has a high refractive index, for example 1.965. The support plate 201 and the plate 360 may be for example made of glass or a polymer.

An iterative process is then executed in which, at each step, a reference beam 95 and an object beam 96 interfere at a first position of the matrix of holograms 250; then the set consisting of the support plate 201, the holographic film 251 and the plate 360 is moved relative to the prism 350 until a second position of the matrix of holograms 250 is reached.

For example, the reference and object beams 95, 96 originate from a same fiber laser source provided with a power divider (not represented). The reference beam 95 reaches the holographic film 251 through the prism 350 and the plate 360. The object beam 96 reaches the holographic film 251 through the support plate 201. An incidence angle Ψ of the reference beam 95 on the prism 350 is such that the reference beam 95 forms an angle at the holographic film 251 with respect to a normal to a main plane of the holographic film 251, equal to the angle φᵥ.

An incidence angle Ψ′ of the object beam 96 on the support plate 201 is such that the object beam 96 forms an angle with respect to the normal to the main plane of the holographic film 251. equal to the angle φ′ of a corresponding extraction structure 61.i.j facing which the hologram 250 is to be positioned. The angles Ψ and Ψ′ are adjusted by optical devices not represented. The reference beam 95 has a divergence and spectral characteristics similar to or identical to a reflected beam 92 in the cover 200 derived from an extraction structure 61.i.j. The object beam 96 has a divergence and spectral characteristics similar to or identical to the pixel beam 93 in the cover 200, intended to be extracted from the display device 1 by the corresponding extraction structure 61.i.j. The angle Ψ′ can be modified from one step to another of the iterative process. Recording the matrix of holograms 250 is facilitated when the angle γ is less than or equal to 45 degrees.

The support plate 201 is then removed with the holographic film 251. The holographic film 251 is transferred with the support plate 201 to the cover 200 to obtain the display device 1 of FIG. 12C.

Now, a first method for manufacturing the stamp 310 will be described in connection with FIGS. 9A to 9E. This method results in making a stamp 310 specially designed for the nanoimprint manufacture of extraction structures 61.i.j as represented in FIG. 2A.

In FIG. 9A, a master substrate 102 of crystalline silicon is provided. The master substrate 102 may be derived from a monolithic plate of crystalline silicon or a plate of the Silicon On Insulator (SOI) type. This is herein an SOI plate, after a possible silicon epitaxy regrowth. It comprises a plate 401, a crystalline upper layer 403 and a stop layer 402 interposed and in contact with the plate 401 and the crystalline upper layer 403. The crystalline upper layer 403 is for example of crystalline silicon with an orientation (100) or (110). The stop layer 402 is for example of silicon oxide.

A hard mask 404 is then formed on an upper face 102.1 of the crystalline upper layer 403, the latter being located on one side of the crystalline upper layer 403 opposite to the stop layer 402. The hard mask 404 comprises openings 404.1 passing through the hard mask 404 from one side to the other. The openings 404.1 are through trenches, parallel to a common direction and to the upper face 102.1. The hard mask 404 is for example of silicon oxide. The openings 404.1 are herein distant by a center-to-center distance equal to L_{C} in the sectional plane of FIG. 9A.

In FIG. 9B, trenches 276 are etched in the crystalline upper layer 403 through the openings 404.1 by anisotropic wet etching. When the master substrate 102 comprises a stop layer 402, wet etching is selective with respect to the stop layer 402. The trenches 276 each comprise a first face of interest 276.1, a face 276.3 opposite to the first face of interest 276.1 and a bottom connecting the first face of interest 276.1 to the opposite face 276.3. The first face of interest 276.1 and the opposite face 276.3 are crystalline planes of silicon revealed by the anisotropic wet etching. This is for example etching in a tetramethylammonium hydroxide (TMAH) solution or a potassium hydroxide (KOH) solution. Thus, the first face of interest 276.1 and the opposite face 276.3 are smooth and have accurate angular orientations with respect to the upper face 102.1, equal to 35.26 degrees, 45 degrees or 54.74 degrees. Here, the bottom of the trenches 276 consists of the stop layer 402, thus the depth of the trenches 276 is well controlled. The trenches 276 have for example a depth between 500 nm and 5 μm.

In order to obtain a face of interest 276.1 (110)-oriented, it is for example possible to etch a crystalline upper layer 403 (100)-oriented through openings 404.1 oriented in parallel to the direction <001>, with a solution at 90° C. containing 2 mol/L KOH and a surfactant, such as Triton X-100 of the molecular formula C₈H₁₇C₆H₄ (OC₂H₄)₉₋₁₀ OH. The surfactant concentration may be between 20 ppm and 60 ppm. Thus, the face of interest 276.1 forms an angle of 45° with the upper face 102.1. Alternatively, it is possible to replace the solution with a solution at 80° C. comprising 25% by mass of TMAH and about 10 ppm by volume of a surfactant such as a polyoxyalkylene alkyl ether, known under the nomenclature NCW-1002.

Similarly, it is possible to obtain a face of interest 276.1 forming an angle of 54.74° with the upper face 102.1 by etching a crystalline upper layer 403 (100)-oriented through openings 404.1 oriented in parallel to the direction <110>.

In FIG. 9C, the hard mask 404 is removed and a second mask 405 is formed in contact with the crystalline upper layer 403. The second mask 405 fully covers the first face of interest 276.1 of each trench 276 and fully exposes the opposite face 276.3 of each trench. Each part of the second mask 405 facing a trench 276 comprises an edge of interest at the upper face 102.1 parallel to the common direction.

In FIG. 9D, only the parts of the crystalline upper layer 403 exposed by the second mask 405 are etched, by anisotropic dry etching, i.e. the second mask 405 protects the crystalline upper layer 403 during etching. The crystalline upper layer 403 is etched over its entire height, preferably selectively with respect to the stop layer 402. The crystalline upper layer 403 thus structured comprises a second face of interest 276.2 facing each first face of interest 276.1 corresponding to an edge of interest of the second mask 405. The second faces of interest 276.2 are here substantially orthogonal to the upper face 102.1. At the end of FIG. 9D, a reference mold 300 is obtained which comprises protruding parts with geometric shapes and arrangements corresponding to the high index regions 260 of the extraction structures 61.i.j. Each protruding part extends from a first face of interest 276.1 to a second face of interest 276.2. The reference mold 300, or master mold, is intended for the manufacture of stamps 310 for making in series display devices 1 implementing nanoimprint lithography.

In FIG. 9E, a stamp 310 is made from the reference mold 300. A soft layer, for example of an elastomer such as polydimethylsiloxane (PDMS), is formed on the reference mold 300 so as to be in contact with the protruding parts and the stop layer 402. The soft layer constitutes the stamp 310. It comprises trenches 312, each of which has a shape corresponding to a protruding part of the reference mold 300. Thus, each trench 312 comprises a first face 310.1 and a second face 310.2 corresponding respectively to the first face of interest 276.1 and to the second face of interest 276.2 of a protruding part of the structured crystalline upper layer 403. The first face 310.1 is therefore smooth and accurately and reproducibly oriented. The same is therefore true of each inclined face 275.1 corresponding to a first face 310.1 of the stamp 310 and of each input face 131 corresponding to the inclined face 275.1.

When the film 315 is a xerogel, the input faces 131 obtained with such a stamp 310 form an angle γ with the upper face of the substrate 100 typically between 30 degrees and 60 degrees, the heating curing step being able to impact volume of the protruding parts 275. When the film 315 is an UV-curable adhesive, the angle γ is substantially equal to that formed by the first face of interest 276.1 with the upper face 102.1. It should be noted that the step of FIG. 9E can be repeated several times to make several stamps 310.

In FIGS. 13A and 13D, a second method for manufacturing the stamp 310 from the reference mold 300 is described. This method results in making a stamp 310 specially designed for nanoimprint manufacturing extraction structures 61.i.j as represented in FIG. 3. Only the differences with the first method are explicitly described.

The step of FIG. 13A is identical to the step of FIG. 9A.

In FIG. 13B, the second face of interest 276.2 is obtained directly, i.e. each second face of interest 276.2 is a crystalline plane of the crystalline upper layer 403 revealed by the wet anisotropic etching. The first and second faces of interest 276.1, 276.2 are crystalline planes equivalent by symmetry. Thus, the second face of interest 276.2 is also smooth and has a controlled angular orientation relative to the upper face 102.1.

The steps of FIGS. 9C and 9D are omitted. In FIG. 13C, the hard mask 404 is removed.

The step of FIG. 13D makes it possible to obtain a stamp 310 according to a second possibility. It is identical to the step of FIG. 9E. At the end of this method, just like the first face 310.1, the corresponding second face 310.2 is also smooth and accurately oriented. The same is therefore true of each face 275.2 opposite to an inclined face 275.1 corresponding to a second corresponding face 310.2 of the stamp 310, and of the output face 132 corresponding to the opposite face 275.2.

When the film 315 is a xerogel, the output faces 132 obtained with such a stamp 310 form an angle γ with the upper face of the substrate 100 typically between 30 degrees and 60 degrees, the heat curing step being able to impact volume of the protruding parts 275. When the film 315 is an UV-curable adhesive, the angle γ is substantially equal to that of the first second face of interest 276.2 with the upper face 102.1. It should be noted that the step of FIG. 13D can be repeated several times to make several stamps 310 according to the second possibility.

Particular embodiments have just been described. Different alternatives and modifications will become apparent to the person skilled in the art.

1. A device for displaying an image consisting of a set of pixels, comprising:
a substrate provided with an orthogonal reference frame and comprising an upper face,
an illumination module,
a common electrode,
a set of addressing waveguides optically coupled to the illumination module, extending in parallel to an oriented axis xa, parallel to xi,
a set of addressing electrodes extending in parallel to an oriented axis ya, forming an angle β with the axis yi,
a matrix of light extraction structures;
wherein the display device is such that
the common electrode, the matrix of extraction structures, the set of addressing waveguides and the set of addressing electrodes successively extend from the upper face, in distinct planes parallel to the upper face, and such that
each extraction structure of the matrix is arranged at an intersection of an addressing waveguide and an addressing electrode, and comprises:
an intermediate waveguide of a liquid crystal extending in parallel to the upper face from an input face of the intermediate waveguide to an output face of the intermediate waveguide,
wherein the intermediate waveguide is arranged between the addressing electrode and the common electrode so as to switch a refractive index of the liquid crystal along a direction of polarization, from a first level to a second level strictly greater than the first level, when a variation in an electric potential difference is applied between the addressing electrode and the common electrode, and
the input face forming an angle γ with the upper face of the substrate greater than or equal to 30 degrees and an angle equal to the angle β with the axis yi:
a high index region extending from the output face of the intermediate waveguide, to the input face of an adjacent extraction structure of the matrix of extraction structures, the high index region having a refractive index nₚ strictly greater than the first level;
wherein the display device is configured such that for each extraction structure;
the first level, the second level, and the arrangement of the intermediate waveguide with respect to the addressing waveguide are such that an optical mode derived from the illumination module and guided in the addressing waveguide, is at least partly coupled by evanescent coupling from the addressing waveguide to the intermediate waveguide, only when the refractive index of the liquid crystal is equal to the second level so as to generate an emitted beam propagating in the high index region from the output face to the input face of the adjacent extraction structure, and
the angle β is greater than or equal to a strictly positive minimum inclination angle beyond which the emitted beam is reflected by total internal reflection on the input face of the adjacent extraction structure into a reflected beam, to be extracted from the display device into a pixel beam corresponding to the display of a pixel of the image.

2. The image display device according to claim 1, wherein each addressing waveguide of the set has a rectilinear portion; the rectilinear portions form a periodic array with a period p along the axis yi; the addressing electrodes intersect the addressing waveguides at the rectilinear portions; the matrix of light extraction structures is periodic with a period L_{C} along the axis xa; and wherein L_{C} is strictly greater than p.

3. The image display device according to claim 2, wherein L_{C} is such that for each extraction structure, the intensity of the emitted beam is greater than or equal to 80% of the intensity of the optical mode.

4. The image display device according to claim 2, wherein the angle β is equal to
$$arccos ( \sqrt{\frac{p}{{L}_{C}}} ) .$$

5. The image display device according to claim 1, wherein the difference between nₚ and the second level is less than or equal to 0.05 in absolute value.

6. The image display device according to claim 1, wherein, for each addressing electrode, the intermediate waveguides of the extraction structures disposed at the intersections between the addressing electrode and the addressing waveguides of the set are portions of a common planar waveguide.

7. The image display device according to claim 1, wherein the display device further comprises a transparent cover with an optical index nᵥ strictly lower than nₚ, each extraction structure of the matrix further comprises a hologram facing the input face of the adjacent extraction structure configured to deflect the reflected beam so as to reduce a propagation angle in the cover of the reflected beam relative to a normal to a main plane of the cover, and wherein each hologram is housed in the cover or on a face of the cover opposite to the high index region.

8. The image display device according to claim 7, wherein the hologram is a reflection hologram.

9. The image display device according to claim 8, wherein the angle γ is less than or equal to 45 degrees.

10. The image display device according to claim 1, wherein the addressing waveguides each comprise a distinct optical modulator, arranged between the illumination module and the matrix of light extraction structures.

11. The image display device according to claim 1, wherein the image is divided into several contiguous display zones, each corresponding to a set of adjacent addressing waveguides, optically coupled to a light source distinct from the illumination module.

12. The image display device according to claim 1, wherein the display device further comprises an addressing circuit electrically connected to the set of addressing electrodes, the set of addressing electrodes is divided into contiguous addressing zones, each consisting of a group of adjacent addressing electrodes, and wherein the addressing circuit is configured to sequentially polarize, one by one, the addressing electrodes of each addressing zone so as to switch the refractive index of the liquid crystal of the corresponding intermediate waveguides to the second level.

13. The image display device according to claim 12, wherein all addressing zones comprise the same number of addressing electrodes.

14. The image display device according to claim 13, wherein the addressing circuit is configured to simultaneously bias an addressing electrode of each addressing zone.

15. The image display device according to claim 14, wherein the addressing electrodes are arranged such that each pair of addressing electrodes simultaneously biased and belonging to contiguous addressing zones, activate two extraction structures of the matrix disposed at two opposite ends of the matrix of extraction structures and facing two adjacent addressing waveguides.

16. The image display device according to claim 12, wherein the addressing circuit biases the addressing electrodes one by one according to the same sequence in all the addressing zones.

17. The image display device according to claim 1, wherein the display device further comprises an image conversion circuit configured to convert a standard image consisting of an orthogonal matrix of pixels, into the image to be displayed by the display device.

18. The image display device according to claim 17, wherein the image to be displayed and the standard image have the same number of pixels to within 10%, and the same aspect ratio to within 10%.

19. A display system comprising a first and a second image display devices, each according to claim 1, arranged above each other such that pixel beams of the first display device pass through the matrix of addressing structures of the second display device.

20. The display system according to claim 19, wherein the optical modes derived respectively from the lighting modules of the first and second display devices have different wavelengths, wherein the second display device further comprises a transparent cover with an optical index nᵥ strictly lower than nₚ, wherein each extraction structure of second display device further comprises a hologram facing the input face of the adjacent extraction structure configured to deflect the reflected beam so as to reduce a propagation angle in the cover of the reflected beam relative to a normal to a main plane of the cover, and wherein each hologram is housed in the cover or on a face of the cover opposite to the high index region.

21. The display system according to claim 20, wherein the display system is configured to display a color image and the matrices of extraction structures of the first and second display devices are arranged relative to each other such that the sets of pixels of the images to be displayed by the first and second display devices are color sub-pixels of the color image.

22. A display system comprising a first and a second image display devices, each according to claim 1, such that the respective sets of addressing waveguides of the first and second display devices are interlaced in a display plane of the display system, parallel to the upper face of the substrate, and each addressing electrode of the first display device is an addressing electrode of the second display device.

23. The display system according to claim 22, wherein the output faces of the intermediate waveguides of the first and second display devices form an angle with the upper face of the substrate equal to γ, and an angle with the axis yi equal to β.

24. The display system according to claim 22, wherein wherein, for each addressing electrode of the first and second display device, the intermediate waveguides of the extraction structures disposed at the intersections between the addressing electrode and the addressing waveguides of the set are portions of a common planar waveguide, and wherein each common planar waveguide of the first display device is a common planar guide of the second display device.

25. A method for manufacturing an image display device according to claim 1, comprising the following steps:
providing a lower part of the display device comprising the set of addressing waveguides,
providing a cover,
forming a structured layer on the lower part or the cover, by a nanoimprint lithography method, such that the structured layer comprises protruding parts with identical heights, equal to a common height,
forming an adhesive bead on the lower part or on the cover, such that the adhesive bead has a thickness greater than or equal to the common height, delimits a central region, and comprises a through lateral opening communicating with the central region,
transferring the cover to the lower part so that the structured layer plays the role of a spacer setting a gap between the cover and the lower part, and delimits continuous volumes in the central region,
bonding the cover to the lower part by the adhesive bead,
introducing a liquid crystal into each continuous volume via the through lateral opening to obtain the intermediate waveguide of each extraction structure.

26. The manufacturing method according to claim 25, wherein the nanoimprint lithography method comprises the following sub-steps:
forming a reference mold comprising the following tasks:
providing a master substrate of crystalline silicon,
anisotropic wet etching trenches in the master substrate from an upper face of the master substrate so as to coincide a face, so-called face of interest, of each trench with a predetermined crystalline plane of the silicon,
forming a stamp by molding on the reference mold,
forming the structured layer by molding a film with the stamp so that faces of the stamp corresponding to faces of interest form the input faces of the extraction structures of the matrix.

27. The manufacturing method according to claim 26, wherein the stamp is soft, the film is an UV-curable adhesive and forming the structured layer implements UV lighting the UV-curable adhesive prior to removing the stamp.

28. The manufacturing method according to claim 27, wherein the UV-curable adhesive has a refractive index equal to nₚ, and the difference between nₚ and the second level is less than or equal to 0.05 in absolute value.

29. The manufacturing method according to claim 25, wherein the manufacturing method further comprises the following steps:
forming a matrix of holograms comprising the following sub-steps:
providing a support plate and a holographic film on a contact face of the support plate,
transferring a plate with planar and parallel faces to the holographic film,
transferring a prism to a face of the plate opposite to the holographic film,
repeating the following sequence:
lighting a zone of the holographic film by a reference beam forming a predetermined incidence angle with an input face of the prism and an object beam, coherent with the reference beam, forming an angle, so-called display angle, with a normal to the contact face, wherein the incidence angle is predetermined such that the reference beam forms an angle with the contact face equal to an angle of the reflected beam of each extraction structure with the upper face of the substrate,
relatively moving the prism by one pitch of the matrix of holograms;
transferring the holographic film to the display device so as to place each hologram facing an input face of an extraction structure.

30. The manufacturing method according to claim 29, wherein the display angle varies from one iteration to another of the sequence.

31. The manufacturing method according to claim 25, wherein the master substrate has an orientation and the predetermined crystalline plane is a plane or.

32. The manufacturing method according to claim 25, wherein the master substrate is a silicon-on-insulator type wafer.
